(19) United States
(12) Patent Application Publication
(10) Pub. No.: US 2014/0215401 A1
(43) Pub. Date: Jul. 31, 2014

(54) MOBILE TERMINAL AND CONTROL METHOD THEREOF

(71) Applicant: LG ELECTRONICS INC., Seoul (KR)

(72) Inventors: Namyoung KIM, Seoul (KR); Hongmin PARK, Seoul (KR); Dongik KIM, Seoul (KR); Seulki JUNG, Seoul (KR); Hyuntaek KWON, Seoul (KR); Haejung KIM, Seoul (KR); Jeonghwan HWANG, Seoul (KR)

(73) Assignee: LG ELECTRONICS INC., Seoul (KR)

(21) Appl. No.: 14/166,727

(22) Filed: Jan. 28, 2014

(30) Foreign Application Priority Data
Jan. 29, 2013 (KR) 10-2013-0010055
Aug. 13, 2013 (KR) 10-2013-0096098

(51) Int. Cl. G06F 3/0482; G06F 3/0481; G06F 3/0488

(52) U.S. Cl. CPC G06F 3/0482; G06F 3/0488; G06F 3/04817
USPC 715/835

(57) ABSTRACT

A mobile terminal including a wireless communication unit configured to perform wireless communication; a display unit configured to display an electronic calendar; and a controller configured to collect log information related to an event generated on the mobile terminal, receive a selection of a particular day in the electronic calendar, display graphic objects on the display unit corresponding to different categories in response to the selection of the particular day, and display collected log information on the display unit for the particular day related to a category corresponding to a selected graphic object.

### CROSS-REFERENCE TO RELATED APPLICATION

Pursuant to 35 U.S.C. §119(a), this application claims the benefit of earlier filing date and right of priority to Korean Application No. 10-2013-0010055, filed on Jan. 29, 2013, and Korean Application No. 10-2013-0096098, filed on Aug. 13, 2013, the contents of which are incorporated by reference herein in its entirety.

### BACKGROUND OF THE INVENTION

1. Field of the Invention

The present invention relates to a mobile terminal and corresponding method for collecting log information.

2. Background of the Invention

Terminals may be divided into mobile/portable terminals and stationary terminals according. Also, the mobile terminals may be classified into handheld terminals and vehicle mounted terminals. As it becomes multifunctional, a mobile terminal can capture still images or moving images, play music or video files, play games, receive broadcast and the like, so as to be implemented as an integrated multimedia player.

Such mobile terminals can also receive and transmit text messages, capture photos, upload posts on a social network site and the like. However, because the user can perform so many different functions on the terminal, it is often difficult for the user to remember the different functions he or she performed on the terminal.

### SUMMARY OF THE INVENTION

Therefore, an aspect of the detailed description is to provide a mobile terminal and corresponding method for effectively providing log information.

To achieve these and other advantages and in accordance with the purpose of this specification, as embodied and broadly described herein, there is provided a mobile terminal including a log collector to collect log information related to an event generated in the mobile terminal, a display unit to display an electronic calendar, the electronic calendar being divided into a plurality of areas based on days, and a controller to control the display unit to display graphic objects corresponding to different categories, in response to selection of one of the plurality of areas, wherein the controller may output log information related to a category corresponding to a selected graphic object, among the collected log information, when the graphic object is selected, and output log information related to a day corresponding to a selected one area, among the collected log information, when the one area is selected after the graphic object is output.

In accordance with one embodiment, the log information may include at least one of call, message, location, photo, video, social network, health and schedule, and application execution.

In accordance with one embodiment, when the log information is output on the display unit, a log information list including items corresponding to different log information may be output on the display unit.

In accordance with one embodiment, when there is another log information involved with log information corresponding to one of the items included in the list, the controller may output an icon representing the another log information on one portion of the one item.

In accordance with one embodiment, the controller may output at least part of the another log information on an area adjacent to the one item or convert the output list into a list including the item corresponding to the another log information, in response to the selection of the icon.

In accordance with one embodiment, when one of the output log information is selected, the controller may execute a preset function involved with the selected log information.

In accordance with one embodiment, when the selected log information is information related to a call, the controller may originate a call using a phone number included in the selected log information.

In accordance with one embodiment, when a first touch input is applied onto one graphic object of the graphic objects corresponding to the different categories and then a second touch input on which the first touch input is released is sensed, the controller may determine that the one graphic object has been selected. The controller may output preview information corresponding to log information related to the one graphic object on one area of the display unit while the first touch input is applied to the one graphic object.

In accordance with one embodiment, when the second touch input is sensed continuous to the first touch input, the controller may control the display unit to output log information related to the one graphic object, other than the preview information.

In accordance with one embodiment, at least part of log information corresponding to each category may be output on each of the graphic objects corresponding to the categories.

In accordance with one embodiment, when at least two graphic objects of the graphic objects corresponding to the different categories are selected by a preset type of touch input, the controller may combine the log information corresponding to the at least two graphic objects, respectively, such that the log information corresponding to each of the at least two graphic objects can be output simultaneously.

In accordance with one embodiment, in the state that the graphic objects corresponding to the different categories are output, when one of the graphic objects is shifted to a preset area or a touch input starting from the one graphic object is released after being continued by more than a preset length, log information related to the one graphic object may be deleted.

In accordance with one embodiment, a search window for entering a search word to search for log information may be output on one area of the display unit. When the search word is entered on the search window, the controller may search for and output log information corresponding to the entered search word using a natural language processing (NLP) algorithm.

In accordance with one embodiment, the controller may search for log information corresponding to days within a preset duration of time based on a current day corresponding to the entered search word or a day corresponding to log information, which has been output prior to the search word entered. The controller may change the search duration for the log information in response to a drag input onto a preset area on the display unit and search again for log information corresponding to the changed duration.

In accordance with one embodiment, the mobile terminal may further include a wireless communication unit to communicate with an external device through short-range wireless communication. When data is received from the external device, the controller may determine it as an event generation and control a memory to store the received data as log information.

In accordance with one embodiment, one of the graphic objects corresponding to the different categories may correspond to the external device, and when the graphic object corresponding to the external device is selected, the data received from the external device may be output.

In accordance with one embodiment, when a touch input is sensed on one of the plurality of areas corresponding to the days or one of the graphic objects corresponding to the different categories for more than a preset time, the controller may generate on an idle screen an icon corresponding to the one area or the one graphic object with the touch input sensed for more than the preset time.

In accordance with one embodiment, the controller may output log information related to the one area or the one graphic object corresponding to the generated icon, in response to selection of the generated icon on the idle screen.

In accordance with one embodiment, when the log information is output on the display unit, a log information list including items corresponding to different log information may be output on the display unit.

In accordance with one embodiment, the number of log information collected on a corresponding day may be displayed on each of the plurality of areas corresponding to the days.

To achieve these and other advantages and in accordance with the purpose of this specification, as embodied and broadly described herein, there is provided a control method for a mobile terminal which collects log information related to events generated therein, the method including displaying an electronic calendar on a display unit, the electronic calendar being divided into a plurality of areas based on days, displaying graphic objects corresponding to different categories on one of the plurality of areas on the display unit, in response to selection of the one area, and outputting log information related to a category corresponding to a selected graphic object, among the collected log information, when the graphic object is selected, and outputting log information related to a day corresponding to a selected one area, among the collected log information, when the one area is selected after the graphic object is output.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate embodiments and together with the description serve to explain the principles of the invention.

In the drawings:

FIG. 1 is a block diagram of a mobile terminal in accordance with one embodiment of the present invention;

FIGS. 2A and 2B are front perspective views of the mobile terminal in accordance with one embodiment of the present invention;

FIG. 3 is a flowchart illustrating a control method for a mobile terminal in accordance with one embodiment of the present invention;

FIGS. 4A to 4G are conceptual views illustrating the control method illustrated in FIG. 3;

FIGS. 5A to 5H are conceptual views illustrating a method of utilizing log information in the mobile terminal in accordance with the one embodiment of the present invention;

FIGS. 6A to 6F are conceptual views illustrating a method of controlling log information by utilizing an electronic calendar in the mobile terminal in accordance with the one embodiment of the present invention;

FIGS. 7A to 7F are conceptual views illustrating a method of controlling log information by utilizing graphic objects in the mobile terminal in accordance with the one embodiment of the present invention;

FIG. 8 is a conceptual view illustrating a method of sharing log information in the mobile terminal in accordance with the one embodiment of the present invention;

FIGS. 9A to 9C are conceptual views illustrating a method of searching for log information in the mobile terminal in accordance with the one embodiment of the present invention;

FIGS. 10A to 10I are conceptual views illustrating a method of providing or utilizing information related to log information through a predetermined area in the mobile terminal in accordance with the one embodiment of the present invention;

FIGS. 11A to 11C are conceptual views illustrating a method of managing log information related to an upcoming day in the mobile terminal in accordance with the one embodiment of the present invention;

FIGS. 12A to 12E are conceptual views illustrating a method of outputting log information on an idle screen in the mobile terminal in accordance with the one embodiment of the present invention;

FIGS. 13A to 13C are conceptual views illustrating a method of providing additional information related to the log information output; and

FIG. 14 is a conceptual view illustrating a method of setting personal information in the mobile terminal in accordance with the one embodiment.

### DETAILED DESCRIPTION OF THE INVENTION

Description will now be given in detail according to the embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. The accompanying drawings are used to help easily understood the technical idea of the present invention and the present invention is not limited by the accompanying drawings.

Mobile terminals described herein may include cellular phones, smart phones, laptop computers, digital broadcasting terminals, personal digital assistants (PDAs), portable multimedia players (PMPs), navigators, slate PCs, tablet PC, ultra books and the like. However, the present invention can be applied to stationary terminals such as digital TV, desktop computers and the like excluding a case of being applicable only to the mobile terminals.

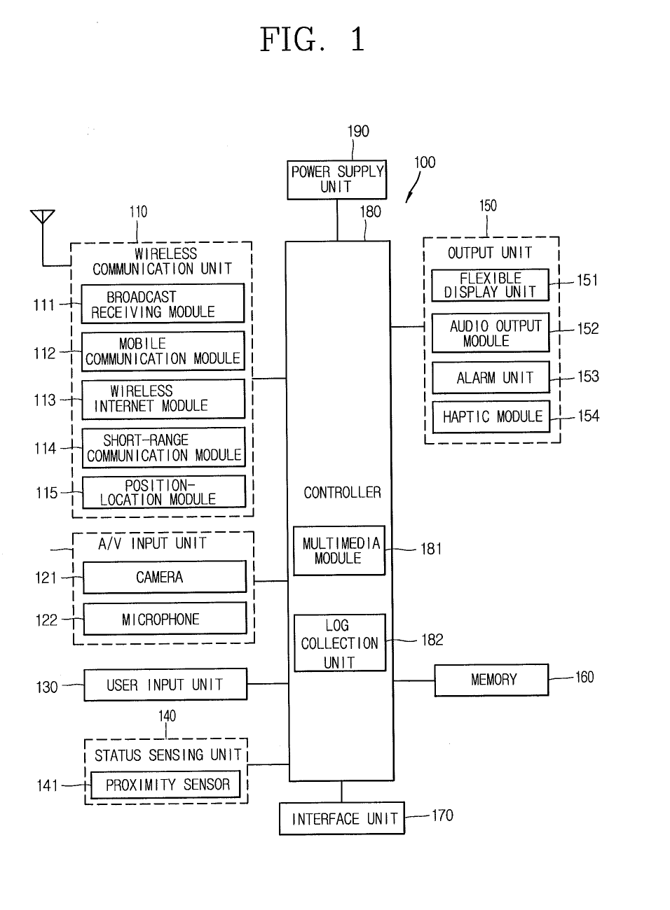

FIG. 1 is a block diagram of a mobile terminal 100 in accordance with one embodiment. The mobile terminal 100 may include components, such as a wireless communication unit 110, an Audio/Video (A/V) input unit 120, a user input unit 130, a sensing unit 140, an output unit 150, a memory 160, an interface unit 170, a controller 180, a power supply 190 and the like. FIG. 1 shows the mobile terminal 100 having various components, but implementing all of the illustrated components is not a requirement. Greater or fewer components may alternatively be implemented.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel. The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems. Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module.

Still referring to FIG. 1, the A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 for the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The sensing unit 140 may include a proximity sensor 141, a stereoscopic touch sensor, an ultrasonic wave sensor and a camera sensor. The sensing unit 140 may be implemented as a three-dimensional (3D) sensor which detects a location of a moving object (hereinafter, referred to ‘target to be sensed’), which is present in a 3D space. Here, the target to be sensed, for example, may be a user's body (e.g., finger), an accessory or the like.

The output unit 150 is configured to output an audio signal, a video signal or a tactile signal. The output unit 150 may include a display unit 151, an audio output module 152, an alarm unit 153 and a haptic module 154.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 can sense which region of the display unit 151 has been touched.

Still referring to FIG. 1, the proximity sensor 141 may be arranged at an inner region of the mobile terminal 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this instance, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer or the like.

The alarm unit 153 outputs a signal for informing about an occurrence of an event of the mobile terminal 100. Events generated in the mobile terminal may include call signal reception, message reception, key signal inputs, a touch input etc. In addition to video or audio signals, the alarm unit 153 may output signals in a different manner, for example, using vibration to inform about an occurrence of an event. The video or audio signals may be also output via the audio output module 152, so the display unit 151 and the audio output module 152 may be classified as parts of the alarm unit 153.

The haptic module 154 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects, including not only vibration, but also arrangement of pins vertically moving with respect to a skin being touched (contacted), air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 154 may be configured to transmit tactile effects (signals) through a user's direct contact, or a user's muscular sense using a finger or a hand. The haptic module 154 may be implemented in two or more in number according to the configuration of the mobile terminal 100.

The memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio output upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the mobile terminal with external devices. The interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as ‘identification device’) may be implemented in a type of smart card. Hence, the identification device can be coupled to the mobile terminal 100 via a port.

Also, the interface unit 170 may serve as a path for power to be supplied from an external cradle to the mobile terminal 100 when the mobile terminal 100 is connected to the external cradle or as a path for transferring various command signals input from the cradle by a user to the mobile terminal 100. Such various command signals or power input from the cradle may operate as signals for recognizing that the mobile terminal 100 has accurately been mounted to the cradle.

The controller 180 typically controls the overall operations of the mobile terminal 100. For example, the controller 180 performs the control and processing associated with telephony calls, data communications, video calls, and the like. The controller 180 can include a multimedia module 181 which provides multimedia playback.

The multimedia module 181 may be configured as part of the controller 180 or as a separate component. The controller 180 can perform a pattern recognition processing so as to recognize writing or drawing input on the touch screen as text or image.

The controller 180 can also execute a lock state in which a user is restricted from inputting a control command for applications when a state of the mobile terminal meets a set condition. Also, the controller 180 can control a lock screen displayed in the lock state based on a touch input sensed on the display unit 151. A log collection unit 182 is also included and will be discussed in more detail later.

The power supply 190 provides power required by various components under the control of the controller 180. The provided power may be internal power, external power, or combination thereof.

Various embodiments described herein may be implemented in a computer-readable medium using, for example, software, hardware, or some combination thereof.

For a hardware implementation, the embodiments described herein may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, microprocessors, other electronic units designed to perform the functions described herein, or a selective combination thereof. In some cases, such embodiments are implemented by the controller 180.

For a software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

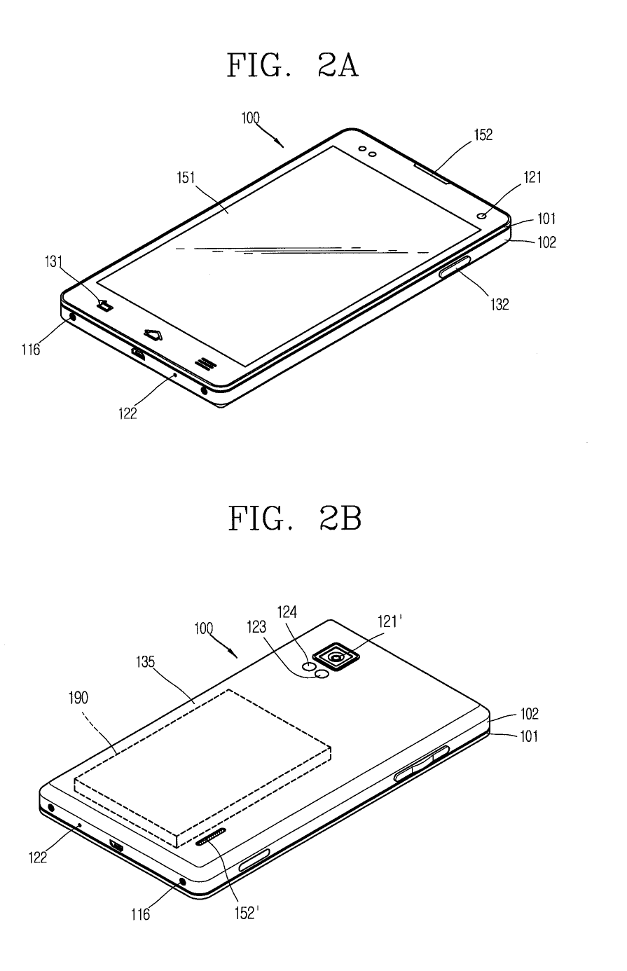

Hereinafter, description will be given of the structure of the electronic device or a mobile terminal in accordance with the embodiment shown in FIG. 1. In particular, FIG. 2A is a front perspective view of the electronic device or the mobile terminal, and FIG. 2B is a rear perspective of the mobile terminal of FIG. 2A.

The mobile terminal 100 disclosed herein is provided with a bar-type device body. However, the present application is not limited to this type of terminal, but is also applicable to various structures of devices such as slide type, folder type, swivel type, swing type, and the like, in which two or more bodies are combined with each other in a relatively movable manner.

As shown in FIGS. 2A and 2B, a device body (hereinafter, referred to as ‘body’) 100 may include a front surface, side surfaces and a rear surface. Also, the body may have both ends formed in a lengthwise direction.

The body may include a case (or referred to as casing, housing, cover, etc.) defining an appearance of the electronic device 100. In this embodiment, the case may be divided into a front face (hereinafter, referred to as ‘front’) case 101 and a rear face (hereinafter, referred to as ‘rear case’) 102. A space formed between the front and rear cases 101 and 102 may accommodate various electronic components. At least one intermediate case may further be disposed between the front and the rear cases 101 and 102. Such cases may be injected using a synthetic resin or be formed of a metal, such as stainless steel (STS), titanium (Ti) or the like.

The front case 101 of the device body is shown having a display unit 151, an audio output module 152, a camera 121, a user input unit 130/131, 132, a microphone 122, an interface unit 170, and the like.

The display unit 151 may occupy most of a principal surface of the front case 101. The audio output module 152 and the camera 121 may be disposed near one of both end portions of the display unit 151, and the user input unit 131 and the microphone 122 on the other end portion of the display unit 151. The user input unit 131, the interface unit 170 and the like may be disposed on side surfaces of the front and rear cases 101 and 102. The microphone 122 may be disposed on the other end of the body 100.

The user input unit 130 may be manipulated to allow inputting of commands for controlling operations of the electronic device 100, and include a plurality of first manipulation units 131 and 132. The plurality of manipulation units 131 and 132 may be referred to as a manipulating portion. Such manipulating portion can employ any tactile manner that a user can touch or tap for manipulation.

The first and second manipulation units 131 and 132 may be set to allow inputting of various contents. For example, the first manipulation unit 131 may be configured to input commands such as START, END, SCROLL or the like, and the second manipulation unit 132 may be configured to input commands, such as a volume adjustment of sounds output from the audio output module 152, conversion of the display unit 151 into a touch recognition mode, or the like.

Referring to FIG. 2B, an audio output module 152′ may further be disposed at a rear face of the terminal body, namely, the rear case 102. The audio output module 152′ can cooperate with the audio output module 152 (see FIG. 2A) to provide stereo output. Also, the audio output module 152′ may be configured to operate as a speakerphone.

A power supply unit 190 for supplying power to the electronic device 100 may be mounted in the terminal body. The power supply unit 190 may be mounted in the terminal body or detachably coupled directly onto the outside of the terminal body.

The rear case 102 may be further provided with a touchpad 135 for detecting a touch input. Similar to the display module 210, the touchpad 135 may be implemented as a light-transmissive type. Here, if the display unit 151 is configured to output visual information from both surfaces, the visual information can be recognized through the touchpad 135. The information output from the both surfaces may all be controlled by the touchpad 135. Unlike to this, a display may further be mounted on the touchpad 135 so as to configure a touch screen even on the rear case 102.

The rear case 102 of the terminal body may further be provided with a camera 121′. The camera 121′ faces a direction which is opposite to a direction faced by the camera 121 (see FIG. 2A), and may have different pixels from those of the camera 121.

For example, the camera 121 may operate with relatively lower pixels (lower resolution). Thus, the camera 121 may be useful when a user can capture his face and send it to another party during a video call or the like. In addition, the camera 121′ may operate with a relatively higher pixels (higher resolution) such that it can be useful for a user to obtain higher quality pictures for later use. The cameras 121 and 121′ may be installed in the terminal body to be rotatable or popped up.

A flash 123 and a mirror 124 may additionally be disposed adjacent to the camera 121′. The flash 123 operates in conjunction with the camera 121′ when taking a picture using the camera 121′. The mirror 124 can cooperate with the camera 121′ to allow a user to photograph himself in a self-portrait mode.

The touchpad 135 may operate mutually in association with the display unit 151 of the front case 101. The touchpad 135 may be provided on the rear of the display unit 151 in parallel to each other. The touchpad 135 may have a size the same as or smaller than the size of the display unit 151.

Also, a mobile terminal according to one embodiment can collect log information corresponding to an event occurred therein. Here, the event may indicate that a control signal is generated in response to a user manipulating the mobile terminal and a function corresponding to the generated control signal is executed. For example, when the user manipulates an icon or a hot key (or hardware key) for executing a capturing (photographing) function, a photo (picture, image) captured in response to the execution of the capturing function may be collected as log information.

The event may also be generated when receiving data from an external server or an external terminal. Here, various types of data may be received from the external server or external terminal. As one example, when a text message or a multimedia message service (MMS) message is received from an external terminal, it may indicate an occurrence of an event. The received text message or MMS message may then be collected as log information. Thus, in a mobile terminal and a control method thereof in accordance with embodiments of the present invention, a method of collecting log information related to an event generated in the mobile terminal and allowing a user to effectively use and manage the collected log information on one screen may be proposed.

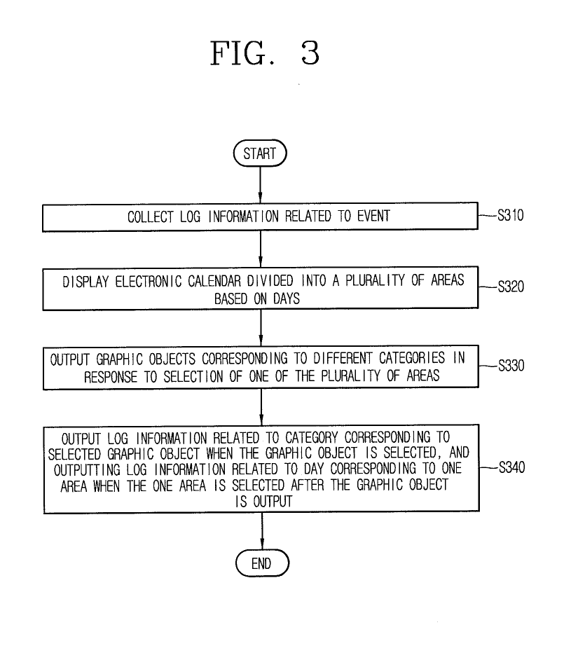

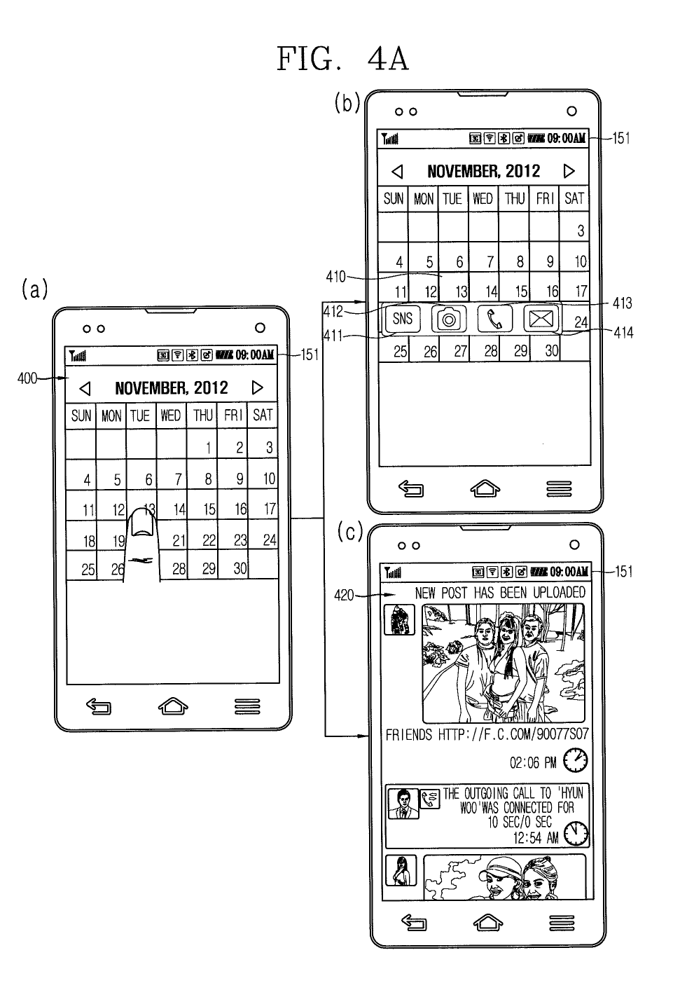

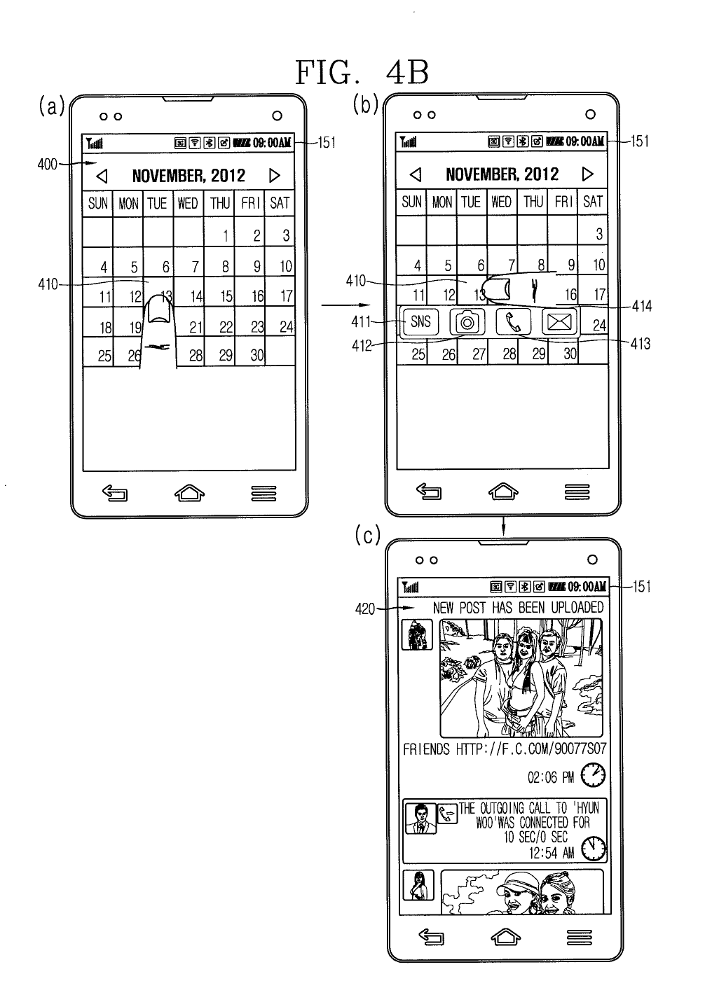

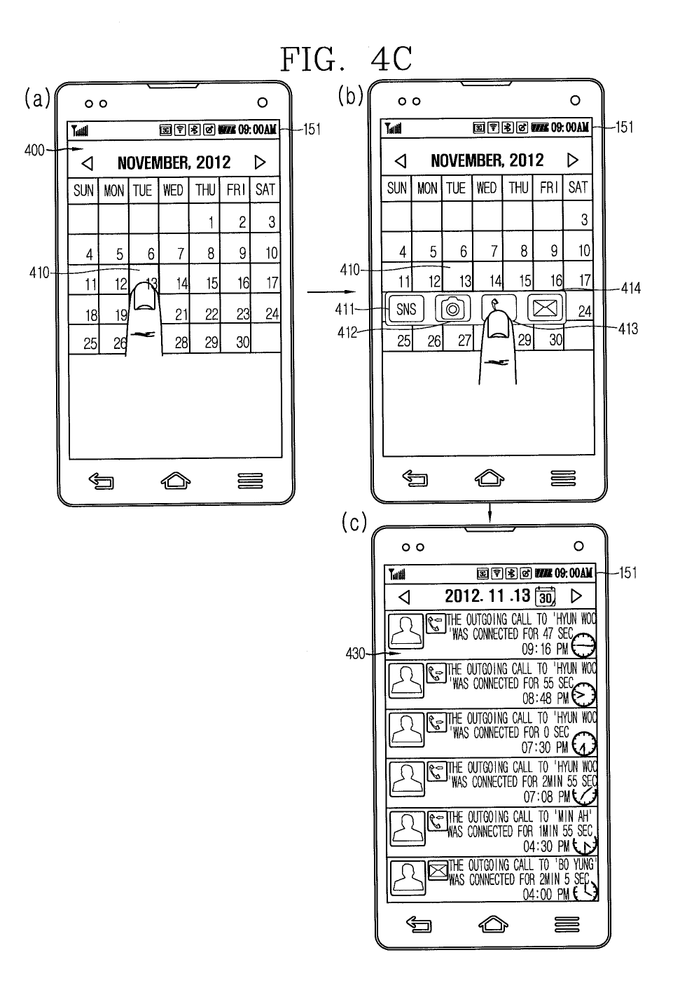

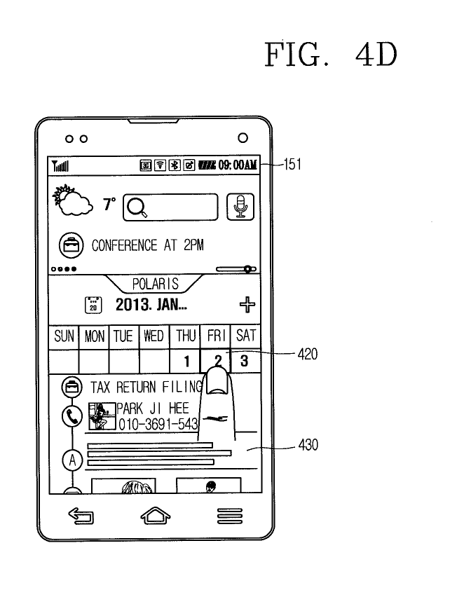

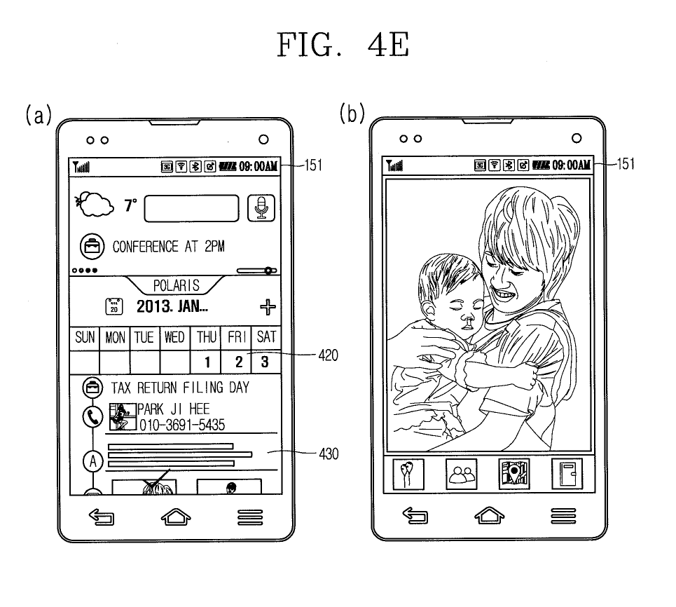

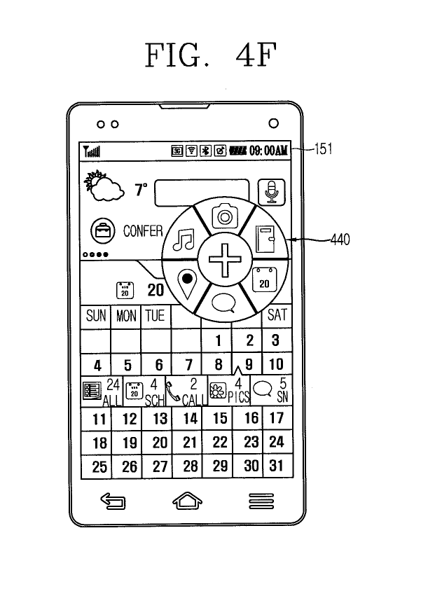

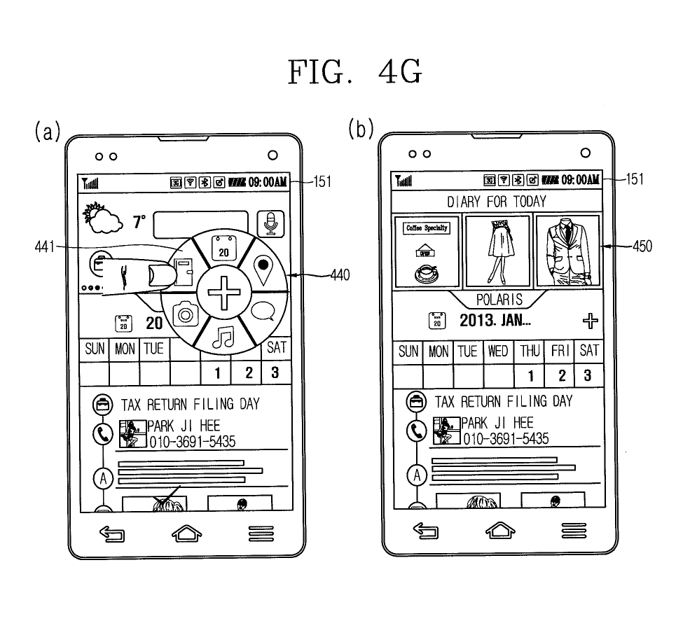

Hereinafter, description will be given in detail of a method of providing log information with reference to the accompanying drawings. FIG. 3 is a flowchart illustrating a control method for a mobile terminal in accordance with one embodiment, and FIGS. 4A to 4G are conceptual views illustrating the control method illustrated in FIG. 3.

As shown in FIG. 3, the controller collects log information related to an event generated in the mobile terminal (S310). The log information may also be collected even while at least one of applications installed in the mobile terminal is executed. That is, the log information may be collected whenever an event is generated, irrespective of an operation of the mobile terminal.

A type of log information collected may be decided based on a user selection. For example, the user may selectively collect only log information corresponding to an event generated in a particular application or function. Namely, according to the user selection, log information corresponding to a call origination or termination event may not be collected, and log information corresponding to a capturing event may be collected.

Such collection of the log information may be perform each time of an event generation even while the collected log information is output and used in the mobile terminal. Examples of the collected log information may include various types of information related to call, text message, MMS message, media (photo, music, video, memo, voice memo, etc.), schedule, alarm, social network service (SNS) related post, position, weather, contact information, execution, installation, update or deletion of applications, and the like.

The log information may include at least one of an icon (or graphic object) indicating a type of the collected log information, contents, and the other party (callee) information related to an event corresponding to the collected log information. Also, in addition to the log information collected by itself, the mobile terminal according to the one embodiment may add tag information input by the user to the collected log information. Therefore, the collected log information may further include the tag information.

Here, the icon (or graphic object) indicating the type of the collected log information may be displayed with a message-related image when the type of log information is a message, and with a phone-related image when the type of log information is a call record. Also, the icon indicating the type of the collected log information may be displayed with a camera image when the type of log information is associated with a photo.

The contents may be related to details of a generated event. As one example, when the generated event is related to a call origination or termination, the contents may include a call-connected time, an originator or terminator, a call conversation, a memo generated during the call and the like. As another example, when the generated event is related to capturing, the contents may be a captured photo (or image). As another example, when the generated event corresponds to post uploading on an SNS site, the contents may be a post (text, video, image, etc.) uploaded on the SNS site.

The other party information related to an event corresponding to the collected log information may correspond to the other party's photo or identification information (phone number, account information, etc.) related to the other party's terminal. The other party's photo may be a photo stored in a contact list (or phonebook) stored in the mobile terminal.

In addition, upon receiving an output request for log information, the controller 180 can output not only the collected log information but also at least one of the icon (or graphic object) indicating the type of collected log information, contents and the other party information related to the event corresponding to the collected log information. Also, when the generated event is an event without the other party information, for example, an event that a preset alarm goes off, the controller 180 cannot output the other party information related to the event when it is requested to output the collected log information corresponding to the alarm event.

The log information may be collected by the log collection unit 182 even time that an event is generated. The log collection unit 182 may be operating under the control of the controller 180. Also, the log information may be collected by the controller 180, without the separate log collection unit 182 in the mobile terminal according to the one embodiment. The collected log information may also be stored in the memory 160.

The thusly-collected log information may be provided to the user through one screen. An electronic calendar which is divided into a plurality of areas based on days may be displayed on the display unit 151 (S320). For example, as shown in (a) of FIG. 4A, an electronic calendar 400 may be divided into a plurality of areas, which correspond to days (for example, first to 30^{th}) included in one month (for example, November), respectively.

The electronic calendar 400 may be output when the user selects a particular icon output on an idle screen. Further, an icon (or graphic object) for outputting the electronic calendar 400 may be output on a state display bar (see (a) of FIG. 4A) indicating state information related to the mobile terminal.

The state display bar may output at least one of a wireless communication method, a data reception state, a data communication method, an alarm setting, a battery state, a GPS use or non-use state, and date and time information. In addition those listed information, various types of information may also be displayed on the state display bar. Also, the state display bar may be output on the display unit 151 even when an idle screen is not output on the display unit 151, for example, when screen information related to an execution of an application is output due to the application being executed. Therefore, the user is facilitated to access the electronic calendar using the icon output on the state display bar.

Besides the icon selection method, the electronic calendar may also be output when a preset type of control command is applied onto the mobile terminal. Here, the idle screen may also be referred to as a home screen page, and indicate a graphic user interface (GUI) which is basically displayed on the display unit 151 when a GUI corresponding to a particular function (or application) is not output on the mobile terminal.

Meanwhile, in the displayed state of the electronic calendar, when one of the plurality of areas is selected, graphic objects corresponding to different categories may be output on the display unit 151, respectively. For example, as shown in (b) of FIG. 4A, when an area 410 corresponding to ‘13^{th} day’ is selected from the plurality of areas, the controller 180 can output graphic objects 411, 412, 413 and 414 corresponding to SNS, media, call and message, respectively.

The number of graphic objects may correspond to the number of types of collected log information or the number of categories. Further, the number of graphic objects output on the display unit 151 may be more various than the graphic objects 411, 412, 413 and 414 corresponding to SNS, media, call and message, respectively. Also, the categories of log information may be sorted based on applications.

When one of the plurality of graphic objects is selected, log information, which is related to the category corresponding to the selected graphic object and has been collected on the day corresponding to the one area. When the one area, other than one of the plurality of graphic objects is selected, log information related to the day corresponding to the selected one area, namely, log information which has been collected on the day corresponding to the selected one area may be output (S340).

For example, as shown in (a) and (b) of FIG. 4B, after the plurality of graphic objects 411, 412, 413 and 414 are output in response to the selection of the one area 410, when the one area 410 is selected again, then the controller 180, as shown in (c) of FIG. 4B, may output every log information collected on the day (for example, 13^{th} day of November, 2012) corresponding to the one area 410.

The collected log information may be output in a list which includes a plurality of items corresponding to different log information, respectively. Sizes of the plurality of items may depend on a quantity of log information. Here, the controller 180 can determine which category corresponds to the log information collected on the day corresponding to the one area 410.

As another example, as shown in (a) and (b) of FIG. 4C, after the plurality of graphic objects 411, 412, 413 and 414 are output in response to the selection of the one area 410, when one graphic object 413 is selected, the controller 180, as shown in (c) of FIG. 4C, may output log information related to a category corresponding to the selected one object 413. For example, when the selected one object 413 corresponds to a call-related category, the controller 180 can output log information which has been collected in relation to calls on the day corresponding to the one area 410.

Therefore, the user may selectively be provided with only log information corresponding to the user-desired category, not with every log information collected on the day corresponding to the one area 410. When a first type of touch input (for example, a touch input extending for a first reference time) is applied to one area 410 of the plurality of areas output on the electronic calendar 400 illustrated in (a) of FIG. 4A, the plurality of graphic objects 411, 412, 413 and 414 may be output as illustrated in (b) of FIG. 4A.

When a second type of touch input (for example, a touch input extending for a second reference time different from the first reference time) is applied to the one area 410, the controller 180, as illustrated in (c) of FIG. 4A, may output log information collected on the day (for example, 13^{th} of Nov., 2012) corresponding to the one area 410.

As another example, as illustrated in FIG. 4D, when one area 420 of the plurality of areas forming the electronic calendar 400, the controller 180 can output pieces of log information, which have been collected on the day (for example, 2nd of Jan., 2013) corresponding to the one area 420, on one area 430 of the display unit 151. Accordingly, when the one area 420 is output, the user may check the log information collected on the day corresponding to the one area 420.

In this instance, the log information may be displayed in such a manner of overlapping at least part of the previously output electronic calendar. Therefore, when an area without the log information output is touched, the displaying of the log information may be ended, and the electronic calendar may then be fully output again. In addition, referring to (a) of FIG. 4E, when one of the pieces of log information output on the area 430 is selected, the controller 180, as illustrated in (b) of FIG. 4E, may output information (or detailed information) corresponding to the selected log information. For example, when the selected log information is relating to a specific picture, the controller 180 can output the specific picture on the display unit 151.

In addition, the controller 180 may output at least one functional key 440 on one area of the display unit 151 as shown in FIG. 4F. After a predetermined function is activated by the functional key 440, when new information is input through the activated function, the controller 180 can collect the new information as log information.

For example, as illustrated in (a) of FIG. 4G, when one functional key 441 (for example, a diary function) is selected, then the controller 180, as illustrated in (b) FIG. 4G, may output selectable diary application items (or list) on one area 450. If only one diary application is present, the controller 180 cannot output the selectable diary application items (or list) on the one area 450, but immediately output an execution screen of the diary application on the area 450.

As described above, in the mobile terminal and the control method thereof according to the one embodiment, the collected log information may be output based on the collected days and the categories.

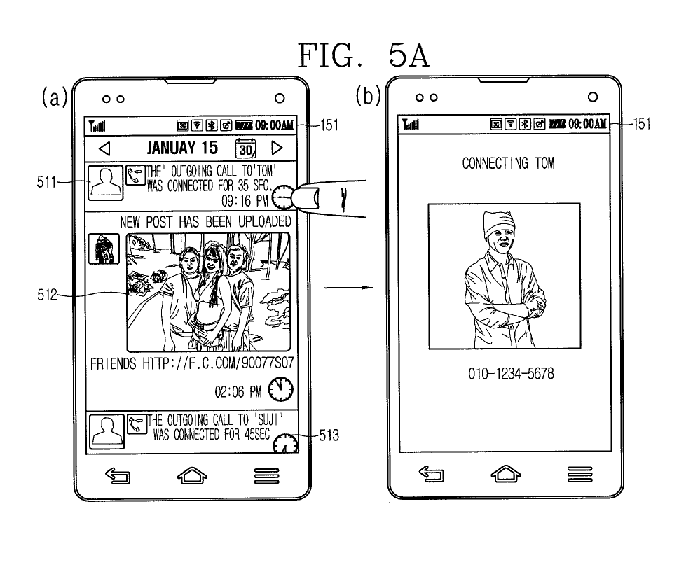

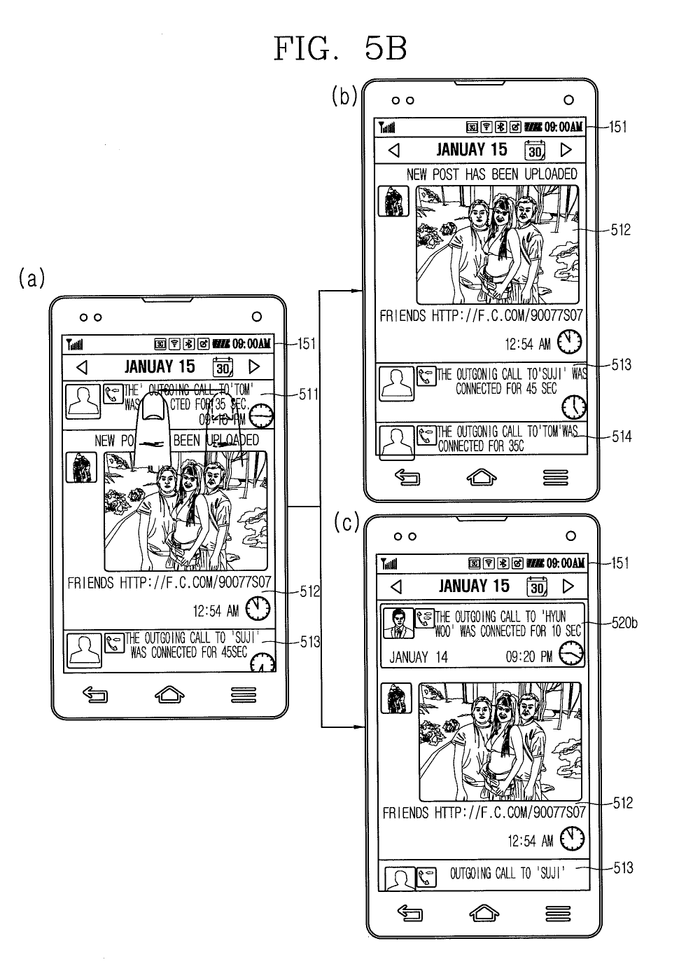

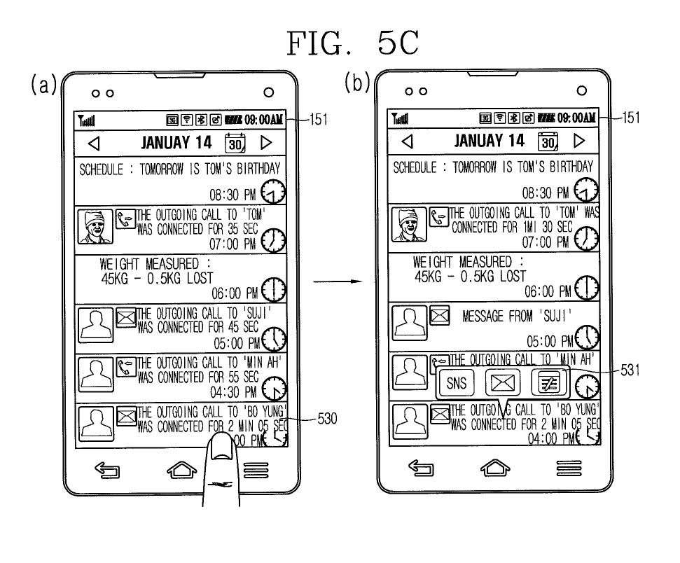

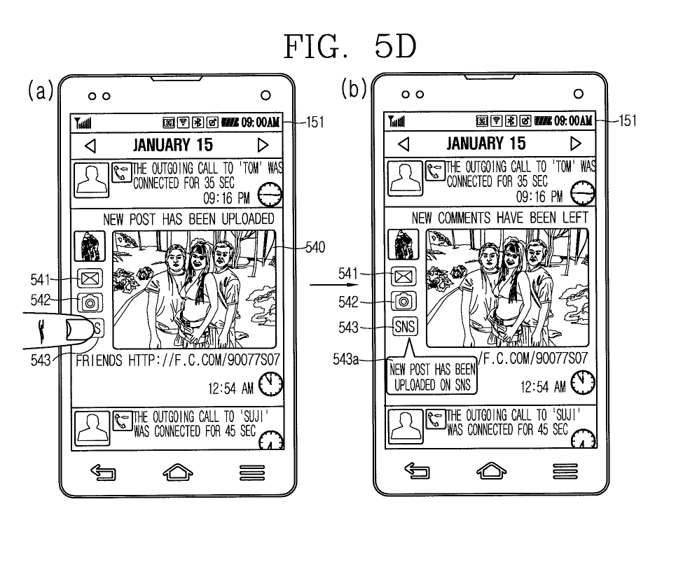

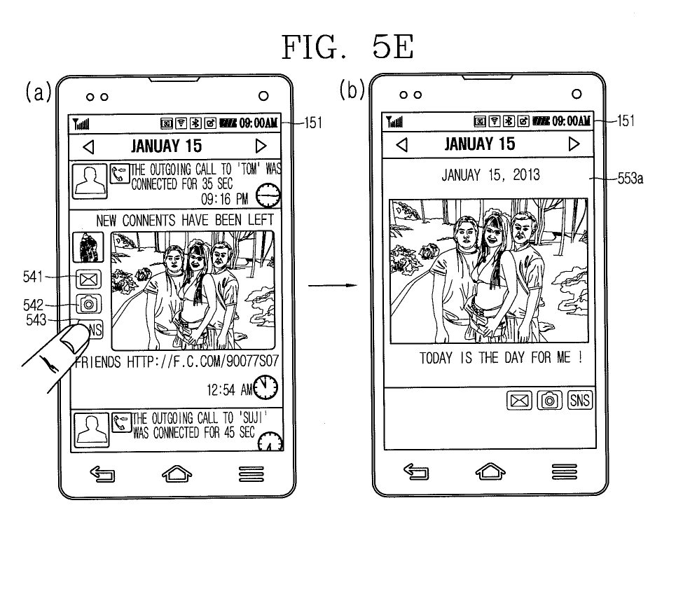

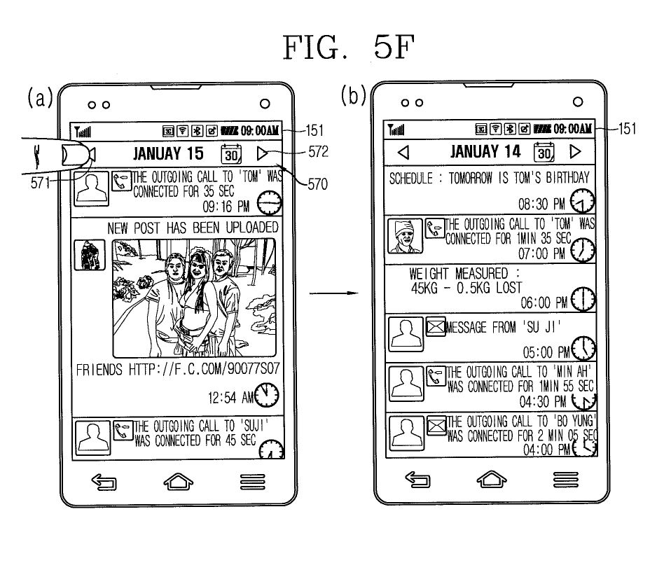

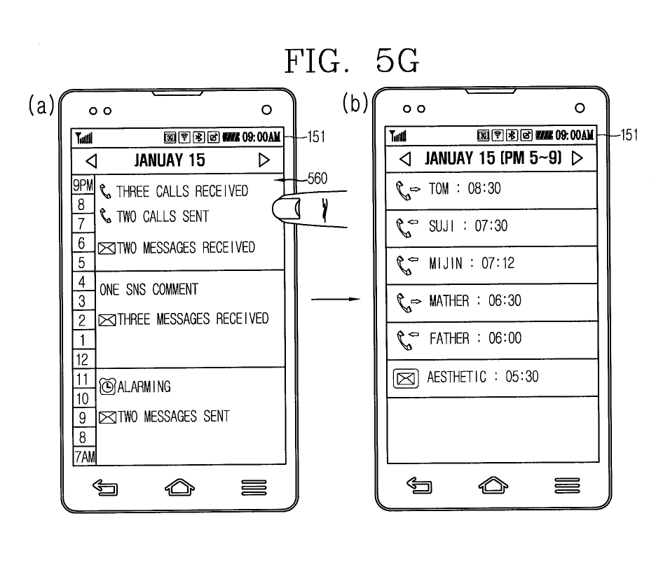

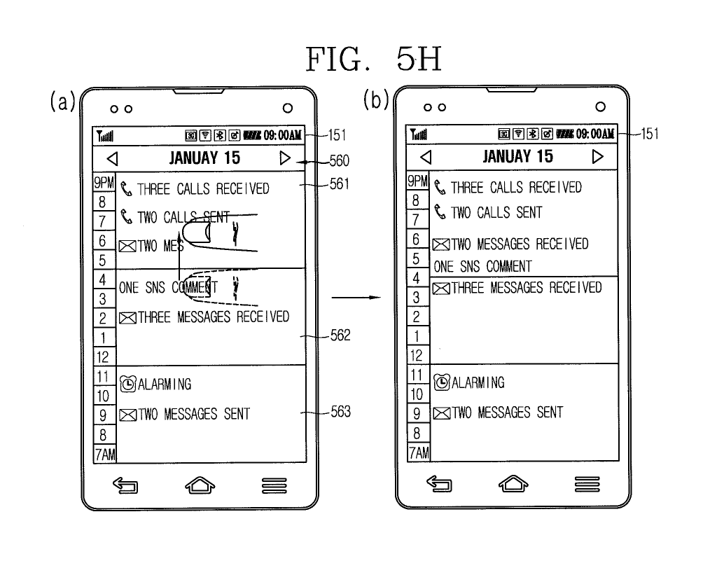

Hereinafter, description will be given in detail of a method of utilizing output log information, with reference to the accompanying drawings, when an area corresponding to a predetermined day is selected or the log information is output in response to selection of one of graphic objects. FIGS. 5A to 5H are conceptual views illustrating a method of utilizing log information in a mobile terminal in accordance with one embodiment.

With log information output on the display unit 151, the mobile terminal according to the one embodiment may execute various functions in association with the output log information, in response a preset type of control command being applied to the output log information.

As one example, referring to (a) of FIG. 5A, after items 511, 512 and 513 corresponding to a plurality of log information are output, when one item 511 is selected, the controller 180, as illustrated in (b) of FIG. 5A, may execute a function of utilizing log information included in the item 511. For example, when the log information included in the item 511 is call-related information, the controller 180 can originate a call using a phone number included in the selected log information.

Further, when the item 512 including SNS-related log information is selected, the controller 180 can access the SNS site and output the SNS site on the display unit 151. As another example, referring to (a) of FIG. 5B, when a preset type of touch input (for example, a drag input or a long-press input) is applied to the one item 511, then the controller 180 can execute a function which matches the preset type of touch input.

For example, when a drag input is applied to the one item 511, the controller may delete (remove) the item 511, as illustrated in (b) of FIG. 5B. When the item 511 is deleted, at least part of an item 514, which corresponds to log information collected on the same day as the day corresponding to log information included in the item 511, may be output on the display unit 151.

As another example, referring to (a) of FIG. 5B, when a preset touch input (for example, a drag input or a long-press input) is applied to the one item 511, the controller 180 can convert the item 511 into another log information 520b, which is different from the log information output on the item 511. For example, the controller 180 can output the item 520b corresponding to log information, which has been collected on a day different from the day on which the log information included in the item 511 was collected, and collected at a time similar to a time that the log information included in the item 511 was collected.

Also, the controller 180 can output different log information depending on directions of touch inputs applied onto the one item 511. For example, when a drag touch input is applied onto one item 511 in a first direction (for example, a drag touch input is applied from left to right), then the controller 180 can output log information collected on a day, which is earlier than a day on which the log information included in the item 511 was collected. Also, when a drag touch input is applied onto the item 511 in a second direction, different from the first direction (for example, a drag touch input is applied from right to left), the controller 180 can output log information collected on a day, which is later than a day on which the log information included in the item 511 was collected.

In addition, even if the item 511 is converted into the another item 520b, the log information included in the one item 511 may not be deleted. Therefore, the item 511 may be output again when the drag touch input is applied again onto the another item 520b.

As another example, referring to (a) of FIG. 5C, when a preset type of touch input (for example, a short touch input or a long touch input) is applied onto one item 530, the controller 180, as illustrated in (b) of FIG. 5C, may output graphic objects 531 corresponding to at least one function which can utilize log information included in the item 530. When one of the graphic objects 531 is selected, the controller 180 can execute a function corresponding to the selected graphic object.

For example, when the log information included in the item 530 is related to a message, the at least one function may be SNS uploading, replying, adding schedule, memo, placing a call and the like. Also, when the log information included in the item 530 is related to a photo, the at least one function may be SNS uploading, sharing with another mobile terminal, uploading to a cloud server, editing, sending message, recognizing a face and the like.

When one function is executed in relation to the log information included in the one item 511, as aforementioned with reference to FIG. 5A, the one function may be immediately executed. When a plurality of functions are executed in relation to the log information included in the one item 511, as aforementioned, graphic objects corresponding to the plurality of functions may be output.

As another example, referring to (a) of FIG. 5D, when there is other log information different from the log information included in the one item 511, graphic objects indicating the different log information may be output. This may allow a user to recognize the presence of inter-related log information and be provided with the related log information by way of selection of the graphic object.

For example, when there are log information corresponding to message, camera and SNS, respectively, which are associated with the log information included in one item 540, graphic objects 541, 542 and 543 corresponding to the message log information, the camera log information and the SNS log information may be output on one area of the one item 540 or an area adjacent to the one item 540. When one 543 of the graphic objects 541, 542 and 543 is selected, the controller 180 can output at least part of the log information corresponding to the one graphic object 543 on one area of the display unit 151. The at least part of the log information may be output in the form of a pop-up window 543a. The pop-up window 543a may be output only while a touch onto the one graphic object 543 is maintained, and then disappeared when the touch is released.

While the pop-up window 543a is output, when the pop-up window 543a is selected, the controller 180 can output the entire log information corresponding to the one graphic object 543 on the display unit 151. The log information corresponding to the one graphic object 543 may be output in the form of a pop-up window or an item of the log information corresponding to the one graphic object 543 may be directly output.

As another example, when the one graphic object 543 is selected as illustrated in (a) of FIG. 5E, the controller 180, as illustrated in (b) of FIG. 5E, may output the entire log information 553a corresponding to the one graphic object 543 on the display unit 151 or output a list including the item of the log information corresponding to the one graphic object 543.

As another example, when a preset type of touch input is applied to a preset area on the display unit 151 or a predetermined graphic object, the controller 180 can output log information, which has been collected on a day different from a day corresponding to the currently output log information. Referring to (a) of FIG. 5F, when a graphic object 571 or 572 output on an area 570 where a date (or a day, for example, 15^{th} of January) is displayed, the controller 180, as illustrated in (b) of FIG. 5F, may output log information which has been collected on a different day (for example, 14^{th} of January) from the day (for example, 15^{th} of January).

Further, when a drag touch input is applied to the area 570 with the day displayed, log information collected on a different day from the day may be output. The controller 180 can also control a day which changes according to a degree of dragging. That is, a distance from the day may change according to drag information.

In addition, as illustrated in (a) of FIG. 5G, the controller 180 can output collected log information in a grouping manner at a predetermined time interval. Here, the time interval for the grouping may be set by a user. When the collected log information is grouped at the predetermined time interval, the controller 180 can briefly output at least part of log information included in the corresponding group. Therefore, the user may directly recognize every log information included in the group.

When an area 560 corresponding to one group of a plurality of groups is selected, the display unit 151, as illustrated in (b) of FIG. 5G, may output log information items corresponding to the one group. As illustrated, at least part of the log information may be output on the output log information items. Further, the display unit 151 may output in detail the log information included in the selected group, in response to the one group selected.

Further, the mobile terminal according to the one embodiment may transmit the log information included in each group to an external terminal at once, or utilize, for example, compress the log information included in each group at once. For example, when a preset type of touch input is applied onto one area of areas corresponding to a plurality of groups, respectively, the controller 180 can output graphic objects corresponding to at least one function (for example, transmission, memo, sharing, etc.), which can utilize log information included in the one area. The controller 180 can utilize log information included in the one area to execute a function corresponding to the selected graphic object.

As aforementioned, at least one of log information grouped by the preset time interval may be shifted to another group based on a user selection. For example, referring to (a) of FIG. 5H, when log information corresponding to 15^{th} of January has been grouped into first to third groups 561, 562 and 563, log information included in the second group 562 may be shifted to the first group 561, as illustrated in (b) of FIG. 5H.

When the log information included in the second group 562 is shifted to the first group 561, the controller 180 can change time information relating to the first group 561 and the second group 562, respectively, taking into account time information included in the shifted log information.

As described above, in the mobile terminal and the control method thereof according to the one embodiment, log information may be controlled and utilized in various manners, in response to a control command for the log information.

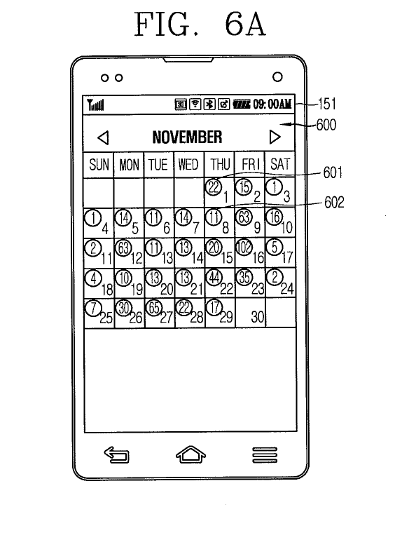

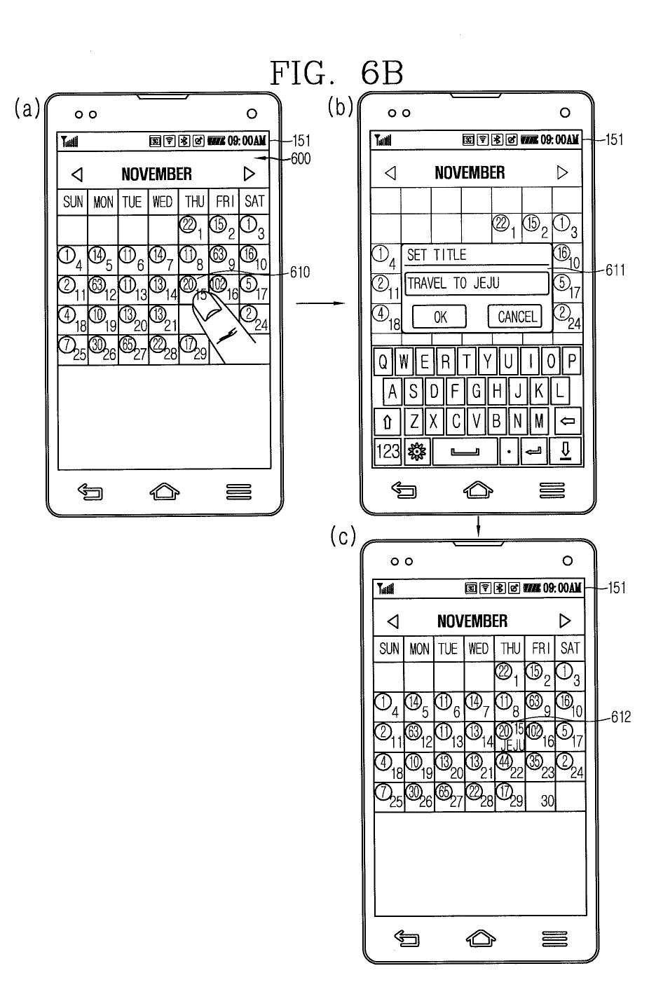

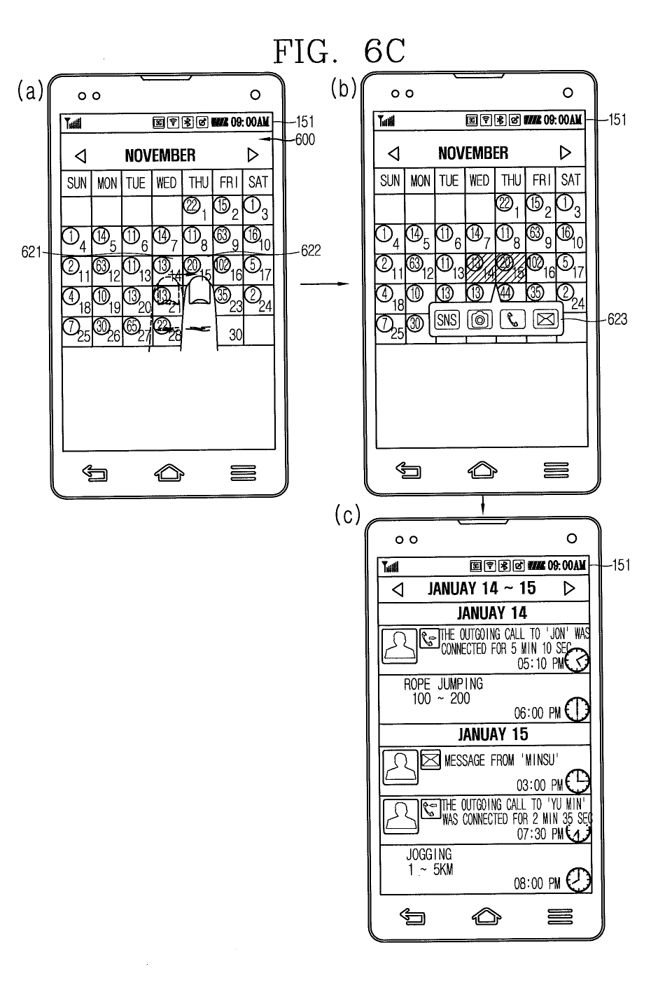

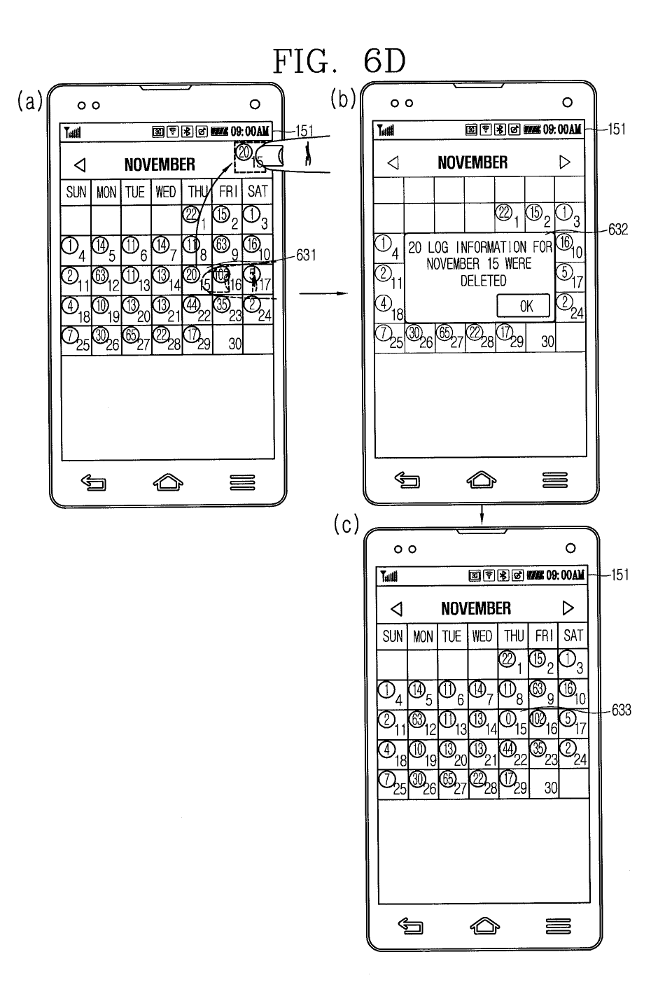

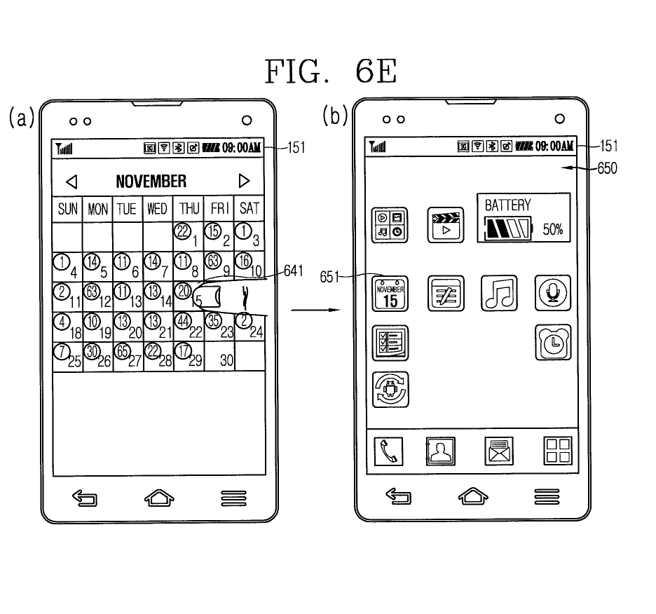

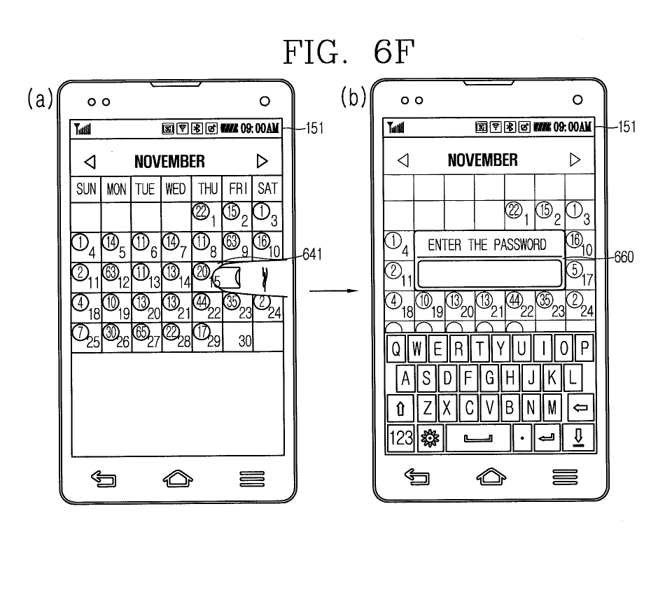

Hereinafter, description will be given in detail of a method of controlling log information on an electronic calendar, with reference to the accompanying drawings. FIGS. 6A to 6F are conceptual views illustrating a method of controlling log information by utilizing an electronic calendar in a mobile terminal in accordance with the one embodiment.

In the mobile terminal according to the one embodiment, as one of methods for providing collected log information by each day, when one day is selected on an electronic calendar output on the display unit 151, the controller 180 can output log information corresponding to the selected day.

Accordingly, referring to FIG. 6A, the display unit 151 may display the electronic calendar which is divided into a plurality of areas based on days. The number of log information collected on days corresponding to the plurality of areas, respectively, may be displayed on the plurality of areas, respectively. For example, the number of log information collected on each day may be displayed on the electronic calendar 600 corresponding to November.

Therefore, when 22 log information have been collected on 1^{st} of November, identification information ‘22’ may be output on one portion of an area 601 corresponding to 1^{st} of November. Also, when 11 log information have been collected on 8^{th} of November, identification information ‘11’ may be output on one portion of an area 602 corresponding to 8^{th} of November. This allows the user to recognize the status of collection of the log information only by viewing the electronic calendar output on the display unit 151.

In addition, in the mobile terminal according to the one embodiment, a title which represents log information collected on a day corresponding to an area selected by the user may be set on the electronic calendar with the plurality of areas divided based on the days. For example, referring to (a) of FIG. 6B, when a preset type of touch input (for example, short touch, long touch, etc.) is applied onto one area 610 of the plurality of areas, the controller 180, referring to (b) of FIG. 6B, may output a pop-up window 611 for receiving a title, which is input by a user for the one area.

When the title is input by the user through the pop-up window 611, for example, a title ‘Travel to Jeju’ is input, the controller 180, as illustrated in (c) of FIG. 6B, may set the input title to a title representing log information collected on a day corresponding to the one area. Also, the title, as illustrated in (c) of FIG. 6B, may be output on at least part of the one area 612.

Further, the controller 180 can store log information corresponding to a predetermined day, separate from other log information, based on a user selection. Here, the controller 180 can generate an application using the log information corresponding to the predetermined day. When the generated application is executed, the controller 180 can allow the log information corresponding to the predetermined day to be output. In this instance, the controller 180 can utilize the set title as at least part of a title of the application. The generated application may be an application corresponding to an e-book function.

In addition, the controller 180 can output log information collected on the day corresponding to the one area by applying a touch input to one of the plurality of areas included in the electronic calendar output on the display unit 151. The controller 180 can also output log information collected on several days. For example, referring to (a) of FIG. 6C, when a drag input is given from one area 621 to at least one another area 622 of the plurality of areas, the at least two areas 621 and 622 may be selected, as illustrated in (b) of FIG. 6C.

Therefore, the controller 180 can output log information collected on at least two days corresponding to the at least two areas 621 and 622, respectively, based on the touch input on the at least two areas 621 and 622 or a touch input on graphic objects 623 corresponding to different categories. Further, when areas to be selected are not continuous, a plurality of areas may be selected by another type of touch input, other than the drag touch input, or a separate icon for selecting a plurality of areas.

Referring to (a) of FIG. 6D, when a touch input which starts from an area 631 corresponding to one day on the electronic calendar is continuously moved by more than a preset length, the controller 180 can delete log information collected on the day corresponding to the area 631, as illustrated in (b) and (c) of FIG. 6D.

Also, when a touch input with a more than a preset length is applied onto the area 631, the controller 180 can move the area 631 along the path of the touch input so as to provide the user with a visual effect. The controller 180 can also output an icon or widget for accessing log information collected on a predetermined day such that the user can immediately enter the log information collected on the predetermined day on an idle screen.

The icon or widget may be output on the idle screen, in response to a control command applied on the idle screen. In addition to this method, referring to (a) of FIG. 6E, when a preset type of touch input (for example, log touch input) is applied onto an area 641 corresponding to a predetermined day in the state of the electronic calendar being output, an icon 651 or widget for outputting log information corresponding to the predetermined day, as illustrated in (b) of FIG. 6E, may be output on the idle screen 650.

When the preset type of touch input is applied to the area 641 on the electronic calendar, screen information output on the display unit 151 may be converted immediately from the electronic calendar into the idle screen 650. Here, when the screen is converted into the idle screen 650 while the touch input on the area 641 is maintained, the controller 180 can output the icon 651 on a point where the touch input is applied. After the icon 651 is moved by another touch input, which is continuous to the touch input, when the touch on the icon 651 is released, the icon 651 may be located on the touch-released point.

In addition, for protecting user's privacy in the mobile terminal according to the one embodiment, when a control command for accessing log information is applied, an input window for allowing a user to enter a password may be output. For example, as illustrated in (a) of FIG. 6F, when a control command for outputting log information collected on a day corresponding to one area 641 is applied, the controller 180 can receive a password entered by the user through an input window 660, as illustrated in (b) of FIG. 6F.

Besides the method of receiving the password after outputting the input window 660 for allowing the user to enter the password, log information corresponding to the one area 641 may also be output when a touch input corresponding to a preset pattern is applied to the one area 641.

The controller 180 can request for the user to enter a password or a preset pattern with respect to all of the collected log information, upon desiring to access the log information. The controller 180 can also request for the user to enter the password or the preset pattern only when there is an access request to log information, corresponding to a day selected by the user, among the collected log information. The controller 180 can output log information when the preset pattern is applied or a preset password is entered.

The foregoing embodiments have illustrated the method of controlling the log information using the touch inputs applied to at least one of the plurality of areas included in the electronic calendar. Hereinafter, description will be given in more detail of a method of controlling log information using touch inputs onto graphic objects corresponding to different categories, which are output in response to selection of one of a plurality of areas, with reference to the accompanying drawings.

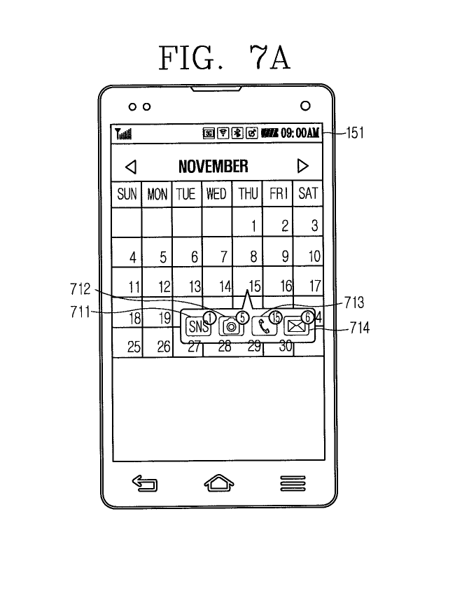

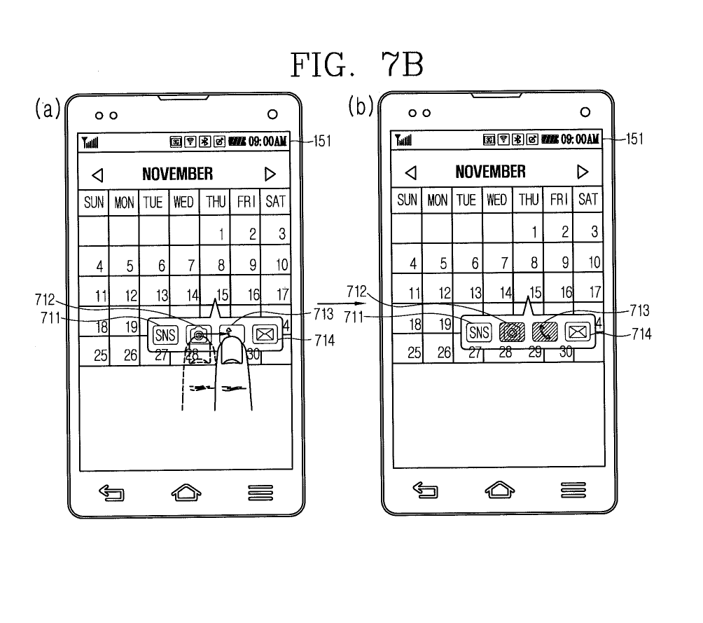

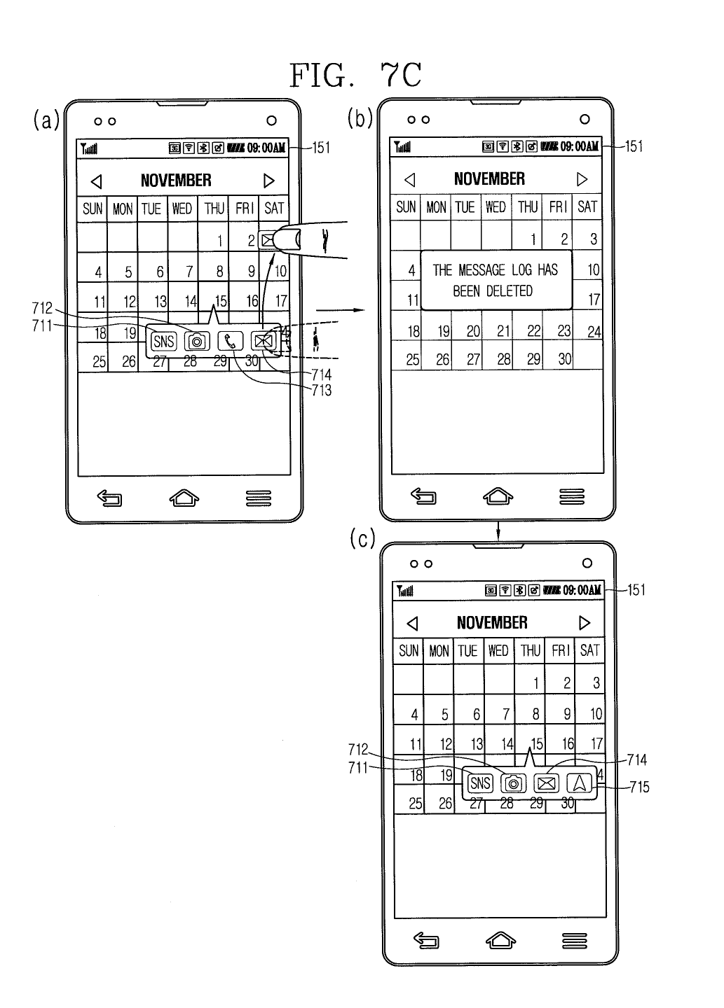

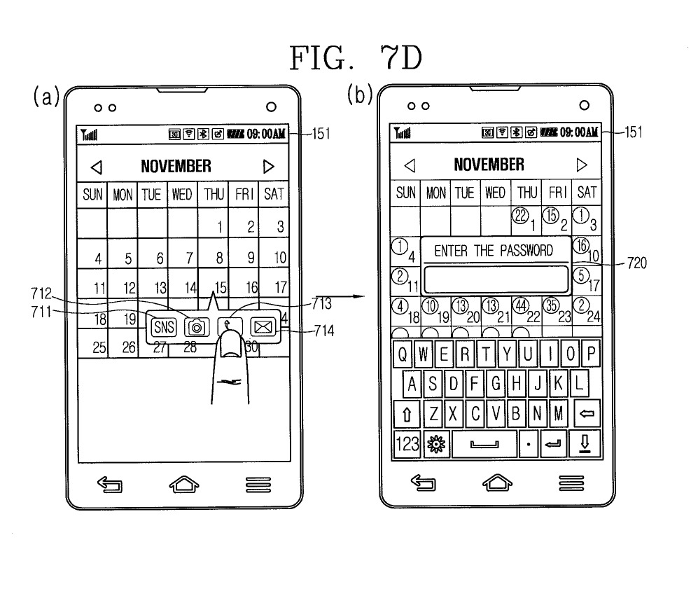

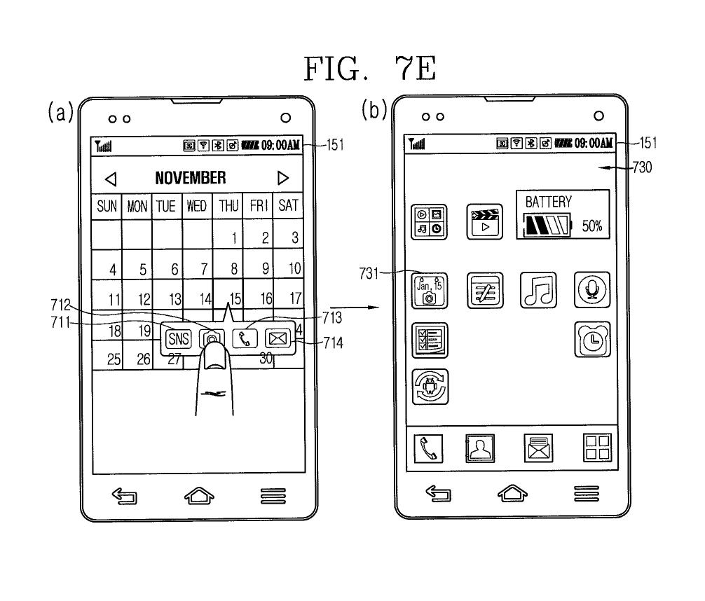

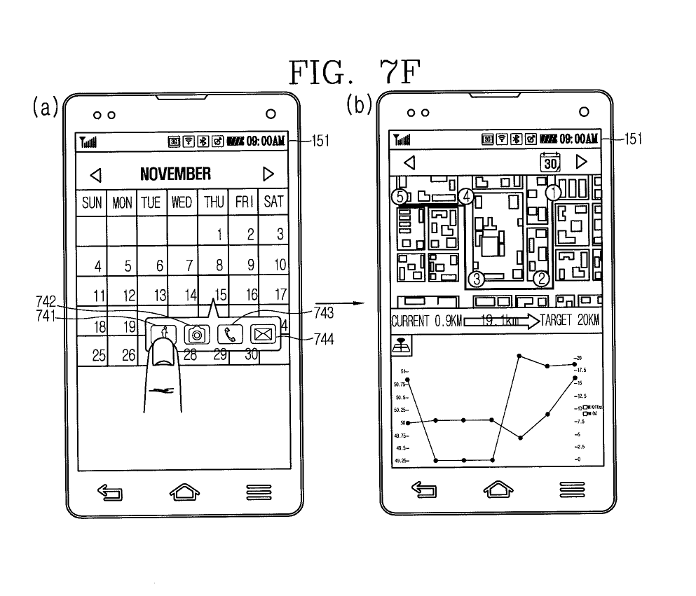

FIGS. 7A to 7F are conceptual views illustrating a method of controlling log information by utilizing graphic objects in a mobile terminal in accordance with one embodiment. In the mobile terminal according to the one embodiment, the number of log information corresponding to each category may be displayed on at least one portion of each of graphic objects 711, 712, 713 and 714 corresponding to different categories as shown in FIG. 7A.

For example, when one log information related to SNS has been collected, identification information ‘1’ may be output on one portion of the SNS related graphic object 711. Further, a graphic object corresponding to a category without log information collected may be displayed in a visually disabled state. For example, such graphic object corresponding to the category with the log information may be more transparent or blurred than the other graphic objects.

The controller 180 can also allow log information corresponding to at least two categories to be output simultaneously. For example, referring to (a) of FIG. 7B, when a touch input is dragged from one graphic object 712 to at least one another graphic object 713 of the plurality of graphic objects 711, 712, 713 and 714, the at least two graphic objects 712 and 713 may be selected as illustrated in (b) of FIG. 7B.

After the drag input is released or when another touch input is applied to at least one of the two graphic objects 712 and 713 after the drag input is released, log information related to the categories corresponding to the two graphic objects 712 and 713, respectively, may be output simultaneously. Further, when graphic objects desired to be selected are arranged discontinuously, a plurality of graphic objects may be selected by another type of touch input, other than the drag touch input, or a separate icon for selecting the plurality of graphic objects.

Referring to (a) of FIG. 7C, when a touch input starting from one graphic objects 714 of the plurality of graphic objects corresponding to different categories is continuously applied by more than a preset length, log information related to the category corresponding to the one graphic object 714 may be deleted, as illustrated in (b) and (c) of FIG. 7C.

When a touch input is applied by more than the preset length with respect to the one graphic object 714, the controller 180 can move the one graphic object 714 along the path of the touch input so as to provide the user with a visual effect. In addition, for protecting user's privacy in the mobile terminal according to the one embodiment, when a control command for accessing log information is applied, an input window for allowing a user to enter a password may be output.

For example, as illustrated in (a) of FIG. 7D, when a control command for outputting log information corresponding to one graphic object 713 is applied, the controller 180 can receive a password entered by the user using an input window 720, as illustrated in (b) of FIG. 7D. Besides the method of receiving the password after outputting the input window 720 for allowing the user to enter the password, log information corresponding to the one graphic object 713 may also be output when a touch input corresponding to a preset pattern is applied to the one graphic object 713.

The controller 180 can request for the user to enter a password or a preset pattern with respect to all of the collected log information, upon desiring to access the log information. The controller 180 can also request for the user to enter the password or the preset pattern only when there is an access request to log information, corresponding to a day selected by the user, among the collected log information. The controller 180 can output log information when the preset pattern is applied or a preset password is entered.

The controller 180 can also output an icon or widget for accessing log information corresponding to at least one of a predetermined category and a predetermined day, such that the user can immediately access the log information collected in correspondence with at least one of the predetermined category and the predetermined day on an idle screen.

The icon or widget may be output on the idle screen, in response to a control command applied on the idle screen. In addition to this method, referring to (a) of FIG. 7E, when a preset type of touch input (for example, log touch input) is applied onto one graphic object 712 of the plurality of graphic objects corresponding different categories, an icon 731 or widget for outputting log information corresponding to the graphic object 712, as illustrated in (b) of FIG. 7E, may be output on the idle screen 730.

When the preset type of touch input is applied to the graphic object 712 on the electronic calendar, screen information output on the display unit 151 may be converted immediately from the electronic calendar into an idle screen 730. Here, when the screen is converted into the idle screen 730 while the touch input on the graphic object 712 is maintained, the controller 180 can output the icon 731 on a point where the touch input has been applied. After the icon 731 is moved by another touch input, which is continuous to the touch input, when the touch on the icon 731 is released, the icon 731 may be located on the touch-released point.

Further, when a first touch applied to one of the graphic objects corresponding to different categories and a second touch on which the first touch is released are sensed, the controller 180 can determine that the one graphic object has been selected. When the first touch input is applied to the one graphic object, the controller 180 can output preview information corresponding to log information related to the one graphic object on one area of the display unit 151. Then, when the second touch is sensed, following the first touch input, the controller 180 can control the display unit 151 to output the log information related to the one graphic object, other than the preview information.

Further, at least part of log information corresponding to a corresponding category may be output on a graphic object corresponding to each of the different categories. Also, when a plurality of log information are present in correspondence with a category, at least part of the plurality of log information may be output on the category in a sequential manner.

The mobile terminal according to the one embodiment may include a wireless communication unit 110 which communicates with an external device through short-range wireless communication. When data is received from the external device, the controller 180 can decide that an event has been generated. The controller 180 or the log collection unit 182 may control the memory 160 to store the received data as log information. Here, the external device may be a health-related device.

For example, the external device may transmit acquired data to the mobile terminal by way of communication with wireless communication unit 110 using at least one communication technology of Bluetooth, radio frequency identification (RFID), infrared data association (IrDA), ultra wideband (UWB) and ZigBee. For example, when the external device is a healthcare product, such as a scale or a pedometer, the mobile terminal may receive health-related data from the external device to use it as log information.

Therefore, referring to (a) of FIG. 7F, the controller 180 can set one graphic object 741 of the graphic objects corresponding to the different categories to correspond to the external device. Consequently, referring to (b) of FIG. 7F, the data received from the external device may be output on the graphic object 741 corresponding to the external device.

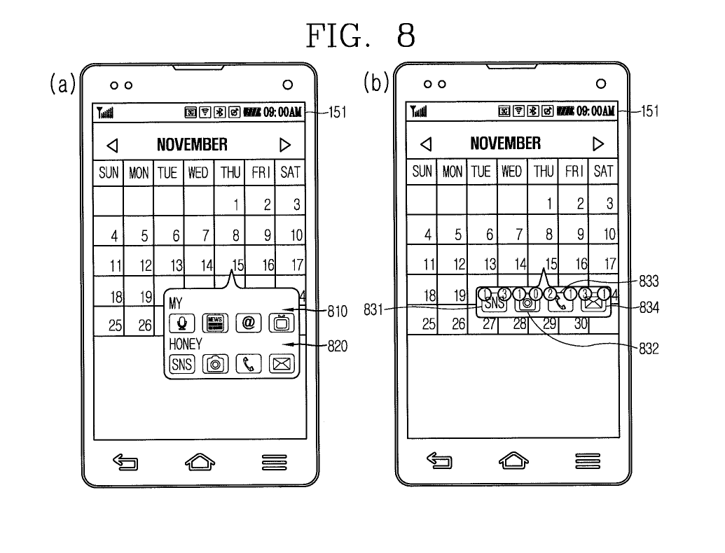

Hereinafter, description will be given in more detail of a method of sharing log information with reference to the accompanying drawings. FIG. 8 is a conceptual view illustrating a method of sharing log information in a mobile terminal in accordance with one embodiment.

A mobile terminal according to one embodiment may receive log information, which is collected in at least one another mobile terminal, from the at least one another mobile terminal, and output the log information. Here, the at least one another mobile terminal may be designated based on identification information (for example, a phone number, account information, etc.) input by a user.

When log information is received from another mobile terminal, the display unit 151, as illustrated in (a) of FIG. 8, may output not only graphic objects 810 corresponding to log information collected in the mobile terminal itself but also graphic objects 820 corresponding to the log information collected by the another mobile terminal.

Accordingly, when one of the graphic objects 820 corresponding to the log information collected by the another mobile terminal is selected, the controller 180 can output log information, which corresponds to the selected graphic object and has been collected by the another mobile terminal. This allows the user to view log information collected by different mobile terminals, respectively.

Meanwhile, in addition to the method described with reference to (a) of FIG. 8, the controller 180 can output log information collected by different mobile terminals on one screen. Here, referring to (b) of FIG. 8, the number of log information, collected by the mobile terminal according to the one embodiment, may be output on one portion of graphic objects 831, 832, 833 and 834 corresponding to different categories, and the number of log information collected by another mobile terminal may be output on another portion, which is different from the one portion. Therefore, the user may easily recognize the number of log information collected by the different mobile terminal.

A type of log information received from at least one another mobile terminal may be decided according to a request by a user having the mobile terminal according to the one embodiment or a selection of a user having the at least one another mobile terminal. The controller 180 can appropriately control a frequency of receiving log information from the at least one another mobile terminal and an update frequency according to a user selection and a communication state of the wireless communication unit 110.

As described above, in the mobile terminal and the control method thereof according to the one embodiment, the log information can be shared with other users, which may facilitate for recognition of schedule and daily routines of other users.

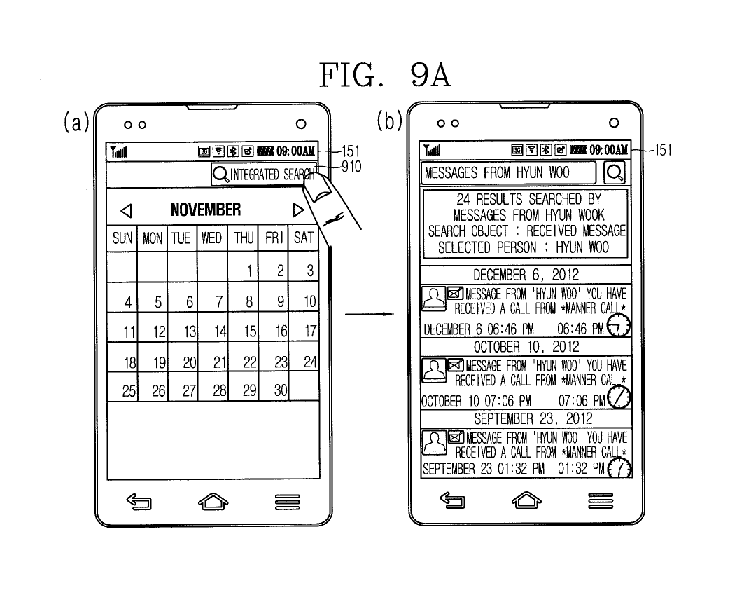

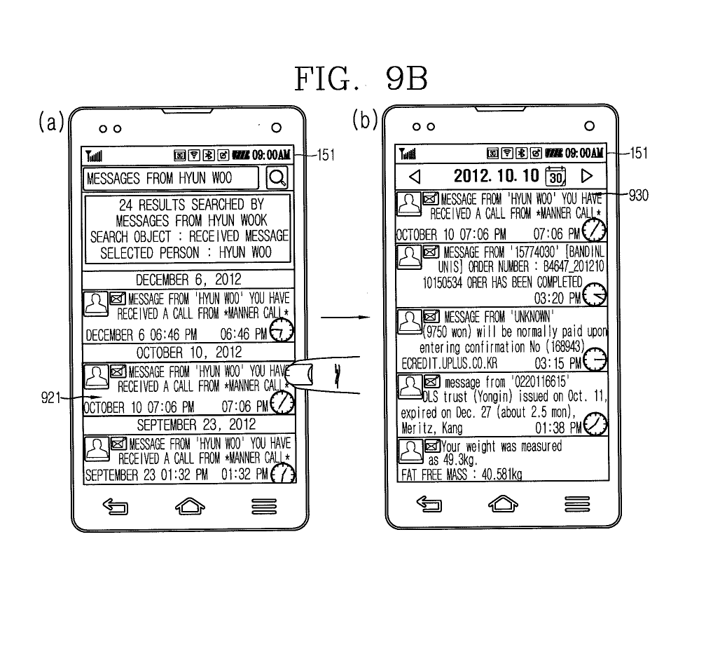

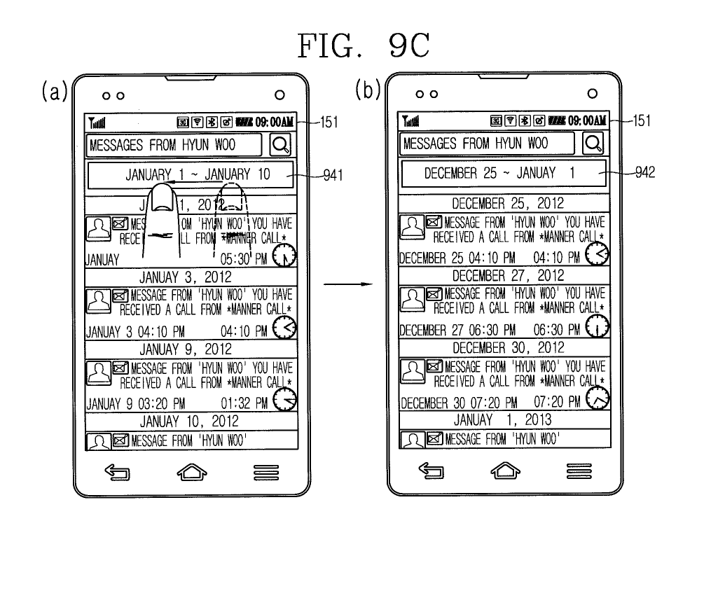

Hereinafter, description will be given in more detail of a method of searching for log information, with reference to the accompanying drawings. FIGS. 9A to 9C are conceptual views illustrating a method of searching for log information in a mobile terminal in accordance with one embodiment.

A mobile terminal according to one embodiment may provide a search function for providing required log information to a user. For the search function, a search window 910, as illustrated in (a) of FIG. 9A, may be output on one area of the display unit 151 on which an electronic calendar is output. When a search word is entered through the output search window 910, the controller 180, as illustrated in (b) of FIG. 9A, may output log information corresponding to the entered search word, using a natural language processing (NLP) algorithm.

The NLP algorithm is related to an artificial intelligence technology which interprets, generates and analyzes human languages. The controller 180 can analyze the entered search word using the NLP algorithm, outputting an exact search result corresponding to the user's intension.

The search window 910, as illustrated in (a) of FIG. 9A, may also be output together with another screen information, other than the electronic calendar. As one example, the search window may be output in the form of widget on an idle screen.

In the mobile terminal according to the one embodiment, the controller 180 can search for log information having tag information corresponding to an entered search word. Even though log information corresponding to the entered search word is present, if the log information does not include tag information corresponding to the entered search word, the controller 180 cannot output the log information as search results.

Therefore, the controller 180 can search for only log information having the same or similar tag information. The controller 180 can also generate an application in form of an e-book, which includes log information having the same or similar tag information.

Referring to (a) of FIG. 9B, when one item 921 is selected from the search results, then the controller 180, as illustrated in (b) of FIG. 9B, may output log information 930 corresponding to a day including the selected item 921. Further, instead of the method of outputting the log information 930 corresponding to the day including the selected item 921, the controller 180 can output detailed information corresponding to the log information which corresponds to the selected item 921, or execute a function (for example, a call origination or message transmission) associated with the log information included in the selected item 921.

Referring to (a) of FIG. 9C, the controller 180 can search for log information corresponding to days within a preset duration based on the current day corresponding to the entered search word or a day, which corresponds to log information which was being output on the display unit 151 prior to the entering of the search word. For example, the controller 180 can search for ‘text messages sent by Hyun Woo’ for a duration of time ‘from 1^{st} to 10^{th} of November.’

In this instance, the controller 180 can change the duration for searching for the log information, in response to a drag input onto a preset area on the display unit 151. For example, referring to (a) of FIG. 9C, when a duration display area 941 is a preset area, the controller 180, as illustrated in (b) of FIG. 9C, may change the search duration of ‘1^{st} to 10^{th} of November’ to a duration of time from 25^{th} of December to 1^{st} of January,’ in response to the drag input onto the duration display area 941. Also, the controller 180 can differently set a duration-changeable range according to the degree of dragging on the duration display area. For example, when a drag input with a first length is applied, a search duration with ‘5-day’ interval may be set based on a reference day. When a drag input with a second length longer than the first length is applied, a search duration with ‘7-day’ interval may be set.

Further, the duration display area 941 or 942 may output at least one of information related to search results and guide information which indicates that the search duration can change through the duration display area 941 or 942. As such, in response to the change in the duration for searching for the log information, the controller 180 can search again for log information corresponding to the changed duration of time.

Although the search duration does not change through the duration display area, as aforementioned, the controller 180 can output log information, which corresponds to the entered search word and is output on the display unit 151, and log information collected during a different duration of time in a manner of scrolling the log information output on the display unit 151 through a drag, slide or flicking touch input with respect to the display unit 151. Therefore, by scrolling the output log information, the user may be provided with log information, which has been collected earlier or later than the output log information.

As described above, in the mobile terminal and the control method thereof according to the one embodiment, the log information which corresponds to the search word entered using the NLP algorithm can be effectively provided.

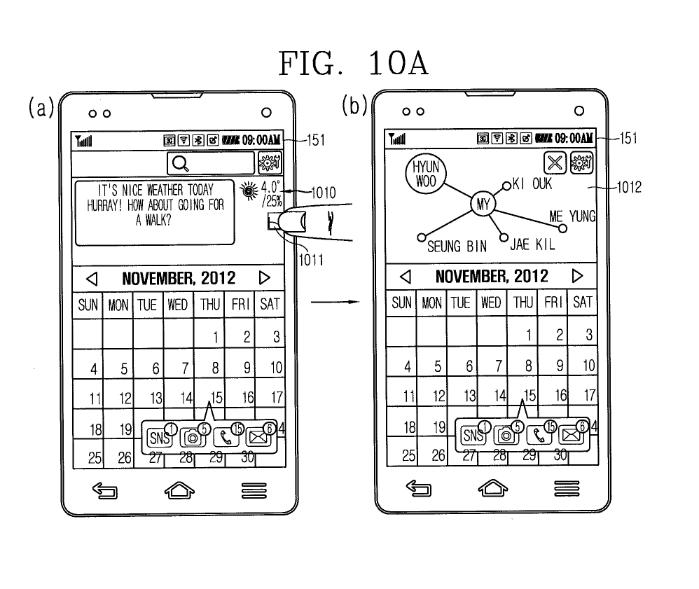

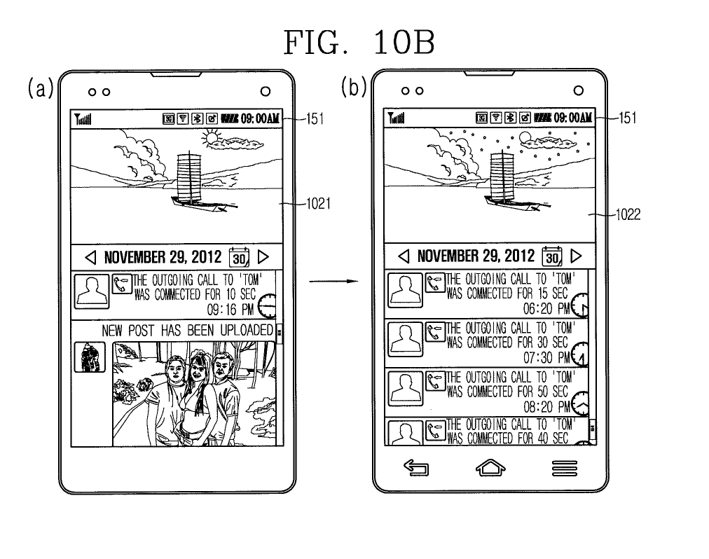

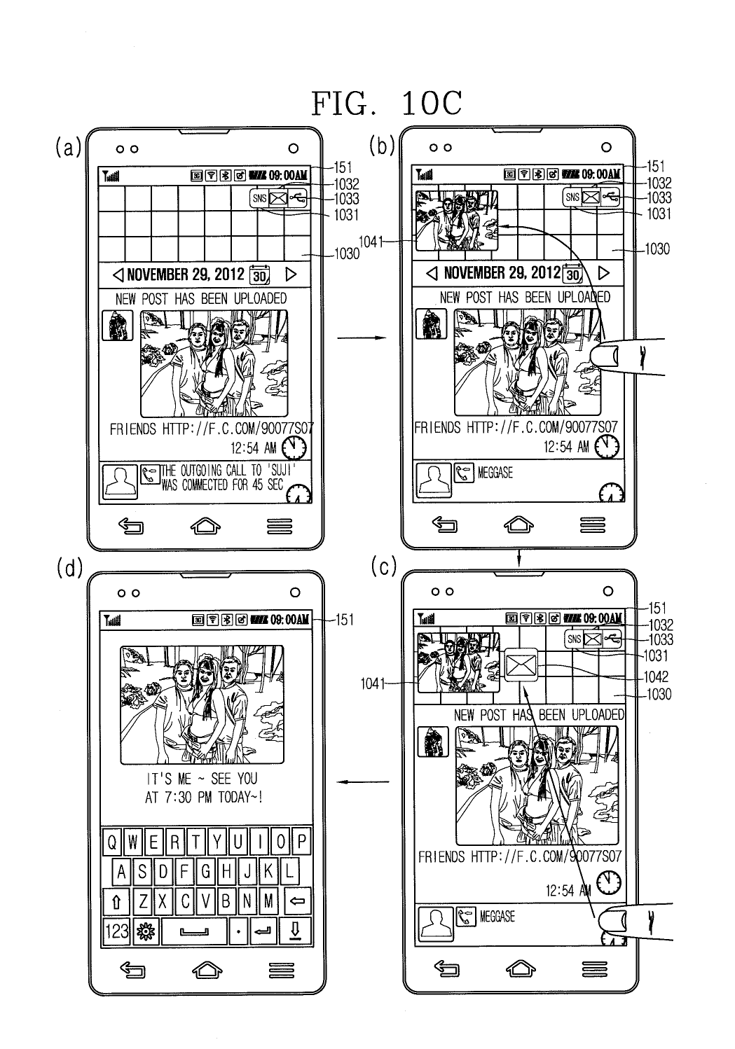

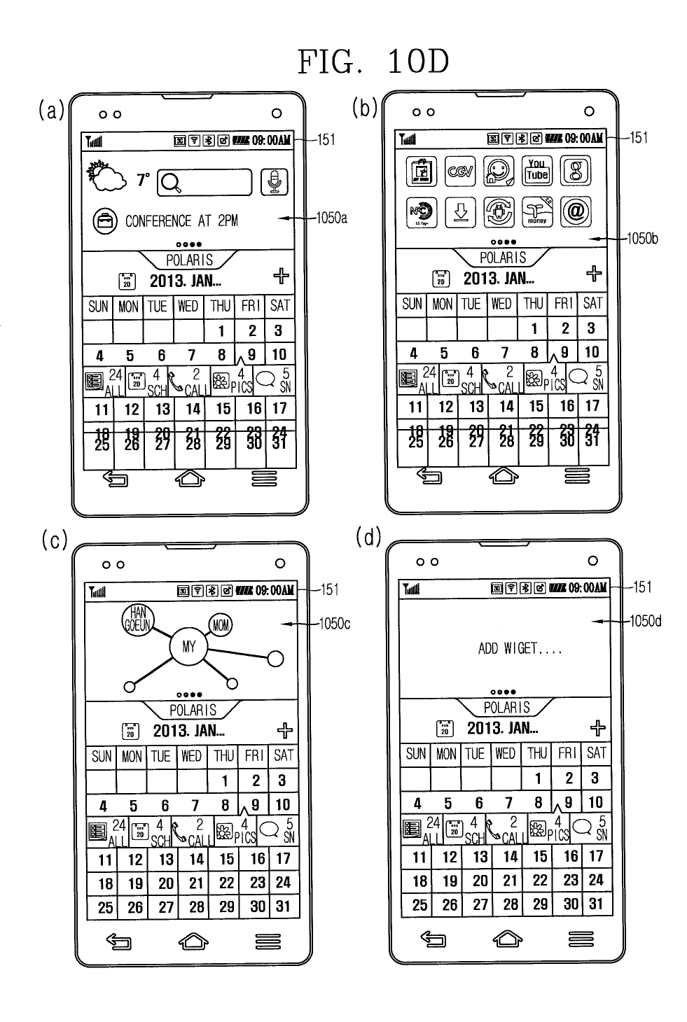

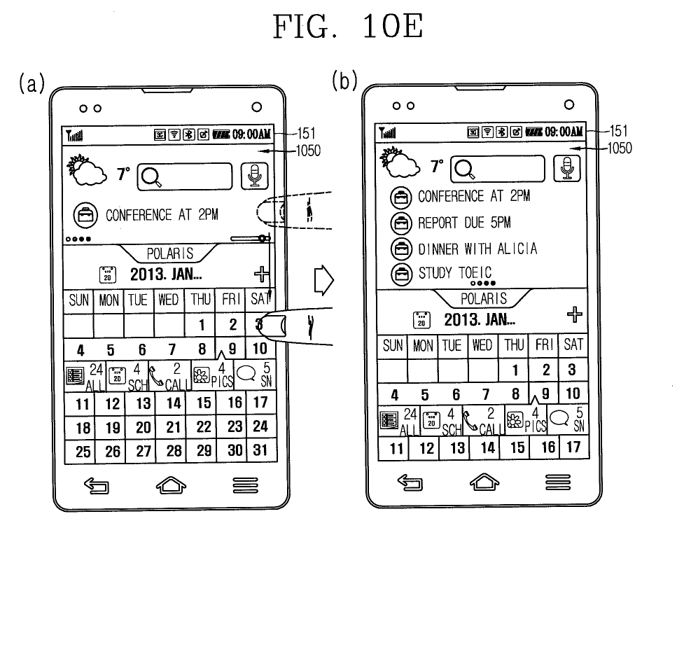

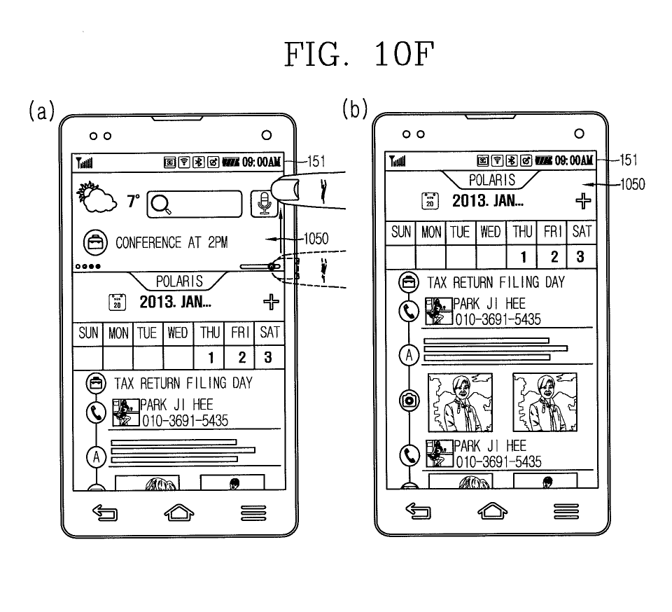

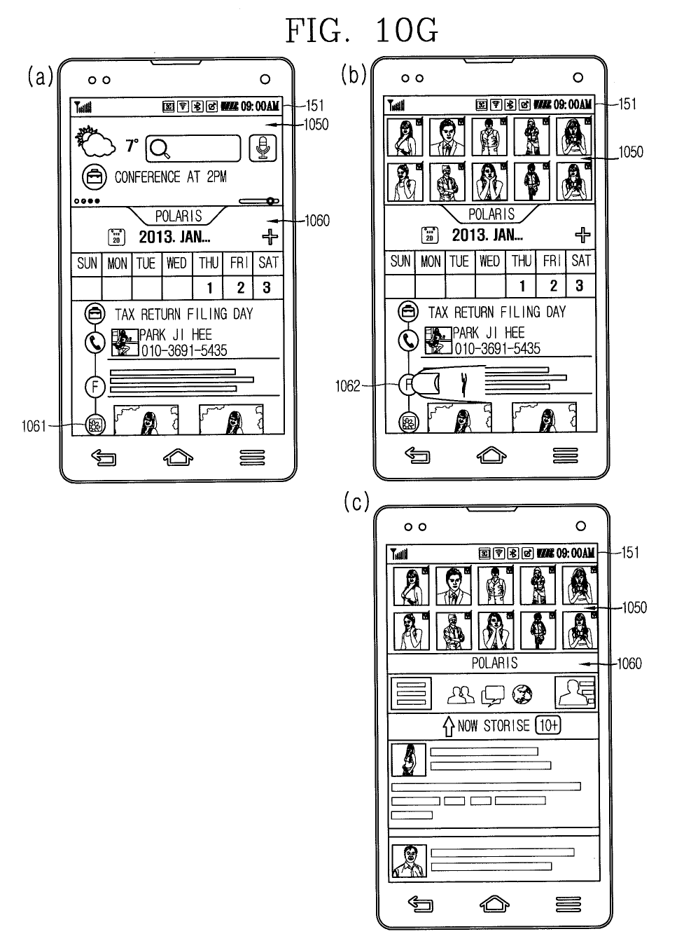

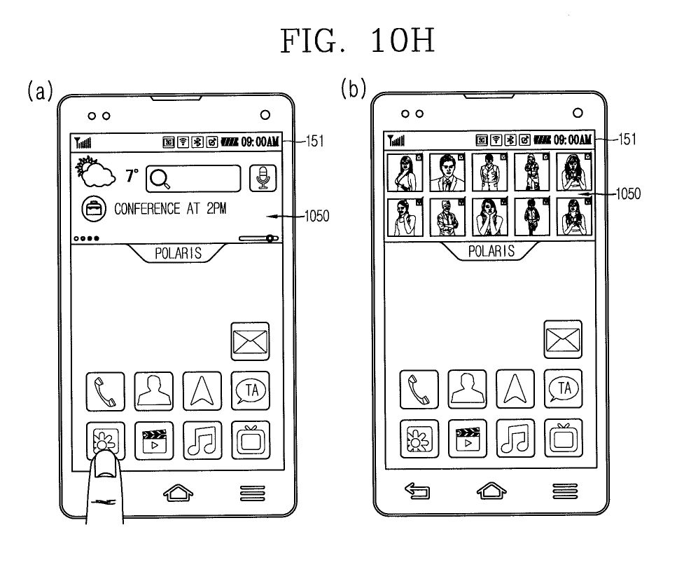

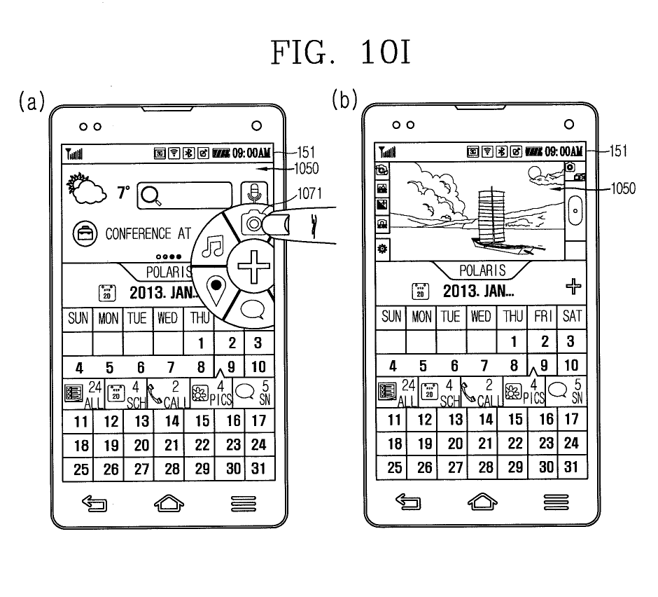

Hereinafter, description will be given in more detail of a method of easily utilizing log information, with reference to the accompanying drawings. FIGS. 10A to 10I are conceptual views illustrating a method of providing or utilizing information related to log information through a predetermined area in a mobile terminal in accordance with one embodiment.

A mobile terminal according to one embodiment may have a predetermined area for providing additional information or an additional function with respect to collected log information. For example, as illustrated in (a) of FIG. 10A, an additional information display area 1010 may be displayed on the display unit 151 together with the electronic calendar. The additional information display area 1010 may output current state information related to the mobile terminal or circumstance information (for example, weather information).

The additional information display area 1010, as illustrated in (b) of FIG. 10A, may also output statistic information 1012. As illustrated in (a) of FIG. 10A, when an icon 1011 related to a statistic function is selected, the controller 180 can output the statistic information, as illustrated in (b) of FIG. 10A. Even if the icon 1011 related to the statistic function is not selected, the statistic information may be output on the additional information display area 1010.

The statistic information output on the additional information display area 1010 is information calculated based on the collected log information. Referring to (b) of FIG. 10A, human network information may be output. In addition to the human network information, the controller 180 can generate statistic information, using collected log information, with respect to various information, such as weight information, information related to calorie burned, information related to an amount of exercise, application use frequency information, mobile terminal use time information, life pattern information and the like.

The type of statistic information output on the additional information display area 1010 may vary according to a user selection. As another example, various types of statistic information may be sequentially output on the additional information display area 1010 under the control of the controller 180. As another example, the type of statistic information output on the additional information display area 1010 may correspond to a type of log information output on the display unit 151.

Referring to (a) and (b) of FIG. 10B, different images may be output on an additional information display area 1021 or 1022 according to a time slot (time zone) of log information output on the display unit 151. For example, as illustrated in (a) of FIG. 10B, when log information collected during a morning time slot is output, an image reminding of the morning time slot may be output on the additional information display area 1021. Referring to (b) of FIG. 10B, when log information collected during an afternoon time slot, an image reminding of the afternoon time slot may be output on the additional information display area 1022. This allows the user to intuitively recognize the time slot, for which the log information has been collected, through the image output on the additional information display area.

The controller 180 can execute an additional function with respect to log information by utilizing the additional information display area. For example, as illustrated in (a) of FIG. 10C, the controller 180 can output at least one function icon 1031, 1032, 1033 corresponding to an additional function on the additional information display area. Referring to (b) and (c) of FIG. 10C, when a touch input starting from at least one log information or log information item is released on an additional information display area 1030, graphic objects 1041 and 1042 corresponding to the at least one log information or log information item may be output on the additional information display area 1030. When one of the at least one function icon 1031, 1032, 1033 is selected after the graphic objects 1041 and 1042 are output on the additional information display area 1030, the controller 180 can utilize the graphic objects 1041 and 1042 to execute a function corresponding to the selected function icon. For example, when the user selects the function icon 1032 corresponding to a message sending function, the controller 180, as illustrated in (d) of FIG. 10C, may input log information corresponding to the graphic objects 1041 and 1042 as a message.

Further, in the mobile terminal in accordance with the one embodiment, instead of dragging the log information or log information item onto the additional information display area, another method may be used to select the log information or log information item.

As one example, a select area (or a check box area) for selecting log information may be output on one area of a log information item. Accordingly, when a touch input is applied onto at least part of the select area, the controller 180 can select the log information item with the touch input applied. A graphic object corresponding to the selected log information item may thusly be output on the additional information display area.

As another example, when one log information item overlaps another log information item, the controller 180 can determine that both of the one log information item and the another log information item have been selected. Here, the controller 180 can output on the additional information display area graphic objects, which correspond to the one log information item and the another log information item, respectively. Here, the selection of the one log information item and the another log information item may be perform when the touch input starting from the one log information item is released on the another log information item. The controller 180 can overlap the one log information item and the another log information item with each other so as to provide a visual effect.

In addition, at least one of information about current situations and information corresponding to a search function may be output on an additional information display area 1050a, as illustrated in (a) of FIG. 10D. Here, the information about current situations may include status information on the mobile terminal (for example, battery information, communication state information, etc.), surrounding environment information (for example, time information, weather information, etc.), schedule information, and the like. Also, the search function may support at least one of a text search and a voice search. Upon supporting the text search, the information corresponding to the search function may be a search word input window.

Also, at least one application icon may be output on an additional information display area 1050b, as illustrated in (b) of FIG. 10D. Such application icons may be icons corresponding to recently-used applications, frequently-used applications by the user, log information-collected applications, and the like.

Also, human network information may be output on an additional information display area 1050c, as illustrated (c) of FIG. 10D. In addition to the human network information, the controller 180 can also generate statistic information, related to various information, such as weight information, information related to calorie burned, information related to an amount of exercise, application use frequency information, mobile terminal use time information, life pattern information and the like.

A widget may also be output on an additional information display area 1050d, as illustrated in (d) of FIG. 10D. A type of widget output on the additional information display area 1050d may depend on a user selection. For example, the widget to be displayed on the additional information display area 1050d may be selected by a user's touch onto the additional information display area 1050d.

The additional information display area 1050, as illustrated in (a) of FIG. 10E, may change in size based on a touch applied to the display unit 151. For example, the controller 180 can increase the size of the additional information display area 1050, as illustrated in (b) of FIG. 10E, in response to a preset type of touch (for example, a drag touch) applied to the additional information display area 1050 in one direction. In this instance, an amount of information to be displayed on the additional information display area 1050 may vary. For example, when the size of the additional information display area 1050 is increased, the controller 180 can increase the amount of information to be displayed on the additional information display area 1050. In addition, as illustrated in (a) and (b) of FIG. 10F, the controller 180 can also reduce the size of the additional information display area 1050. In this instance, the amount of information to be displayed on the additional information display area 1050 may be reduced, and an amount of information to be output on an area except for the additional information display area 1050 may increase.

The increase or reduction of the size of the additional information display area 1050 may depend on a direction of a touch applied to the additional information display area 1050.

In addition, in the mobile terminal disclosed herein, when the user selects a graphic object corresponding to log information or application from which log information has been collected (or an application corresponding to collected log information), the log information or screen information (or an execution screen) related to the log information-collected application may be output on the additional information display area 1050. For example, as illustrated in (a) of FIG. 10G, when a graphic object 1061 indicating photo log information is selected, the controller 180, as illustrated in (b) of FIG. 10G, may output at least part of an execution screen of an application from which the photo log information has been collected on the additional information display area 1050.

When the user additionally selects another graphic object 1062, the controller 180 can output an execution screen of an application corresponding to the graphic object 1062 on an area 1060 on which the electronic calendar has been output as shown in FIG. 10G(c).

Referring to (a) of FIG. 10H, the additional information display area 1050 may be output on a home screen page (or an idle screen, a background screen, etc.). When one application is selected by the user, the controller 180, as illustrated in (b) of FIG. 1011, may output an execution screen of the selected application on the additional information display area 1050.

Besides, as illustrated in (a) of FIG. 10I, when one functional key 1071 is selected, an execution screen of an application corresponding to the selected functional key may be output on the additional information display area 1050.

As described above, in the mobile terminal and the control method thereof according to the one embodiment, the user may be provided with various information related to log information through the additional information display area for outputting the information related to the log information or executing a function related to the log information, thereby enhancing user convenience in terms of the use of the log information.

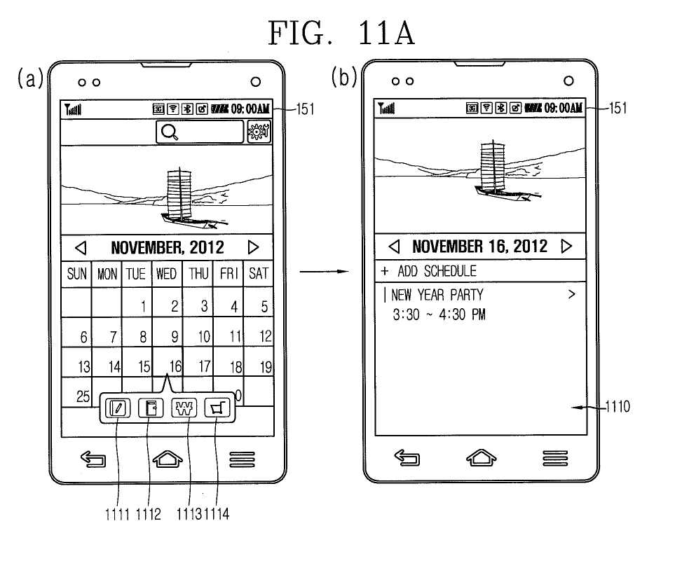

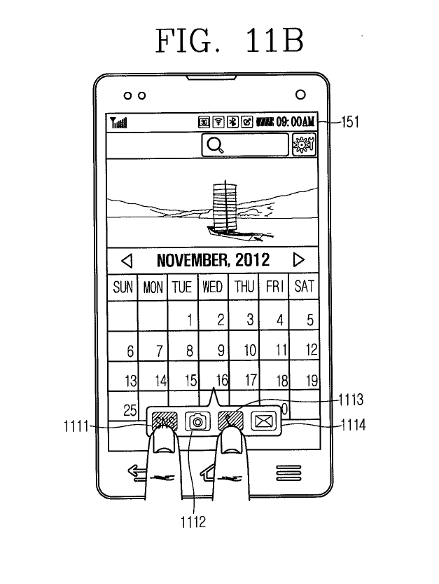

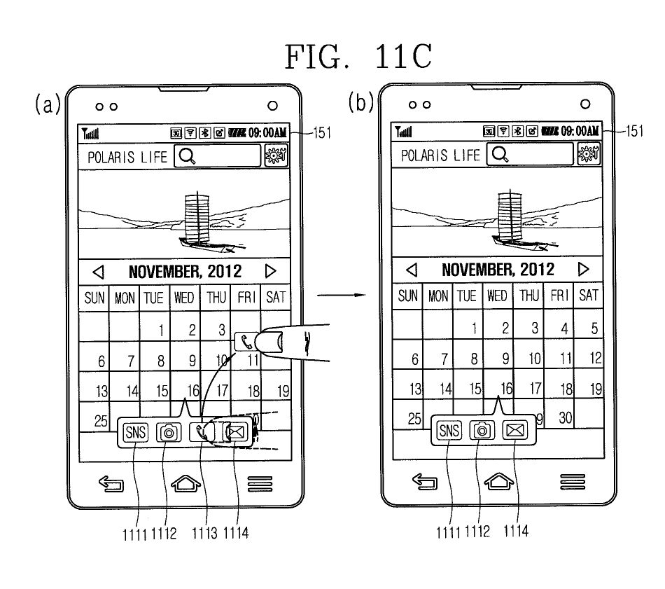

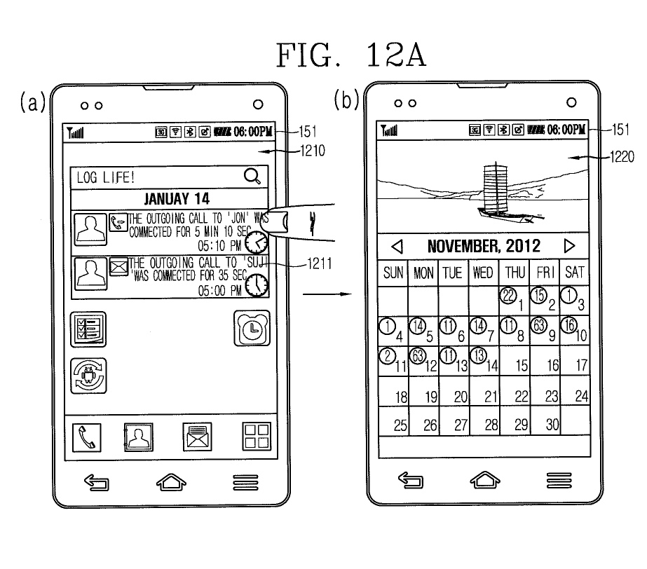

Hereinafter, description will be given in more detail of a method of managing log information related to an upcoming day, with reference to the accompanying drawings. FIGS. 11A to 11C are conceptual views illustrating a method of managing log information related to an upcoming day in a mobile terminal in accordance with one embodiment.

In a mobile terminal according to one embodiment, log information may be collected in correspondence with an event generated in the mobile terminal. Thus, log information may not exist for an upcoming day (date) which has not come yet. Therefore, when an upcoming day other than a past or current day is selected on the electronic calendar, as aforementioned, information other than the collected log information may be output.

As one example, referring to (a) of FIG. 11A, when the current date is 15^{th} of Nov., 2012 and a user selects an area corresponding to 16^{th} of Nov., 2012 on the electronic calendar, the controller 180 can output a plurality of graphic objects (or function icons) 1111, 1112, 1113 and 1114 for storing or viewing schedules, memos, “to-do” things and other information associated with the upcoming day, other than a plurality of graphic objects for outputting log information collected in different categories. For example, when a graphic object (or function icon) 1111 associated with a schedule is selected by the user from the plurality of graphic objects 1111, 1112, 1113 and 1114, the controller 180, as illustrated in (b) of FIG. 11A, may control the display unit 151 to output schedule information, which has been stored in relation to an upcoming day, other than collected log information. Meanwhile, when log information related to the upcoming day is found in previously collected log information (for example, log information related to ‘a date (day) on which a schedule in association with the upcoming day has been stored’), the controller 180 can control the display unit 151 to additionally output the log information related to the upcoming day.

When the upcoming day has come after storing information related to a “to-do” thing (or a to-do list) and the like with respect to the upcoming day by using one of the plurality of graphic objects or another method other than using the graphic object, if the “to-do” thing corresponding to the “to-do” thing-related information is achieved, The controller 180 can output information indicating the achievement of the “to-do” thing as well as the log information related to the “to-do” thing information.

That is, when the “to-do” thing is accomplished, the controller 180 can determine it as an event, collect log information related to the event, and output identification information indicating the accomplishment of the “to-do” thing.

Here, the “to-do” thing-related information may be related to a work that the user has to do using the mobile terminal, for example, placing a call to a certain person, sending a message, capturing a photo more than a preset number of times, and the like.

Referring to FIG. 11B and (a) and (b) of FIG. 11C, when an upcoming day is selected, the controller 180 can output graphic objects 1111, 1112, 1113 and 1114 corresponding to different categories with respect to log information, to preset a category of log information which is to be collected on the upcoming day. For example, referring to FIG. 11B, the controller 180 can collect only log information corresponding to the graphic objects 1111 and 1113, selected by the user, on the upcoming day. Also, referring to (a) and (b) of FIG. 11C, the controller 180 cannot collect log information corresponding to the removed graphic object 1113.

Further, the controller 180 can output the plurality of graphic objects together with the plurality of graphic objects illustrated in FIG. 11A when the upcoming day is selected.

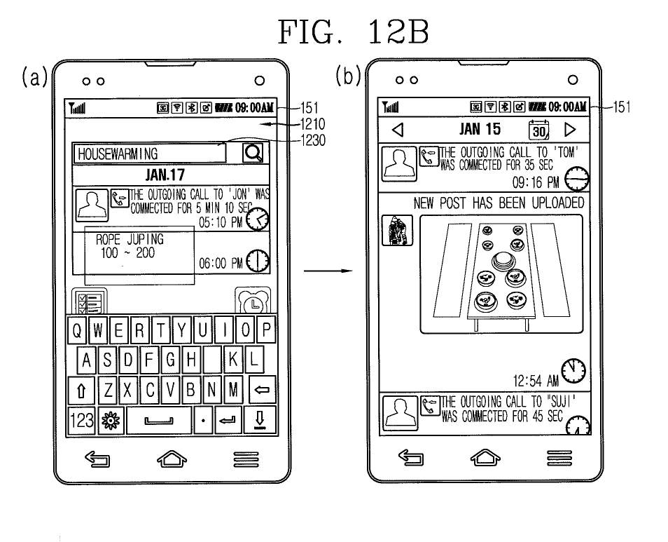

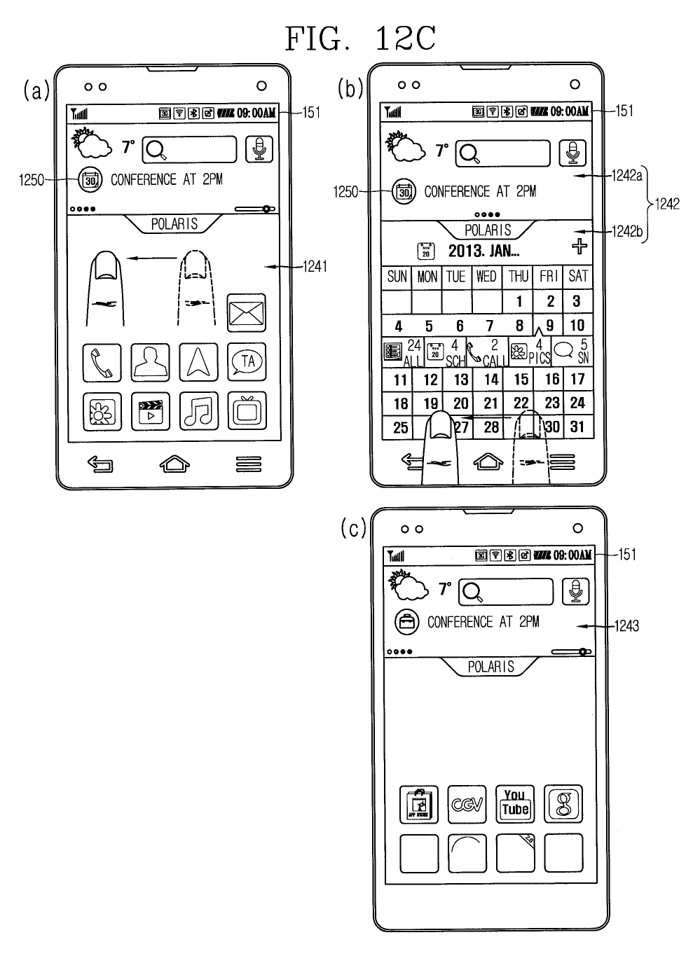

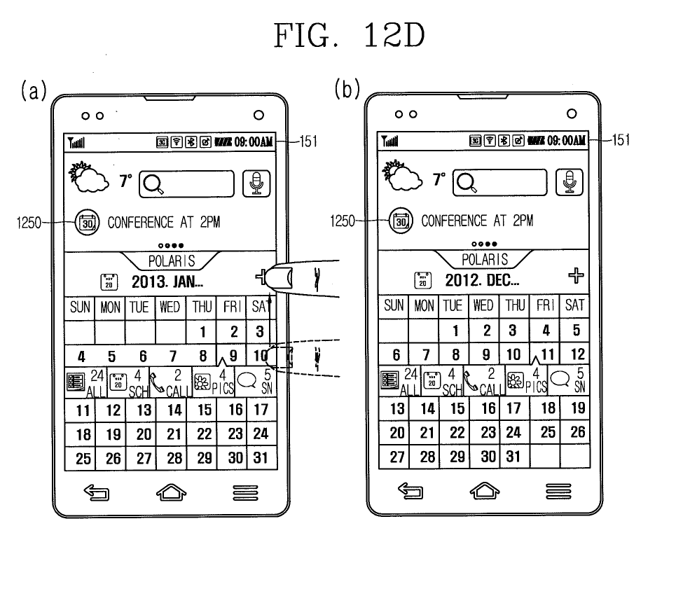

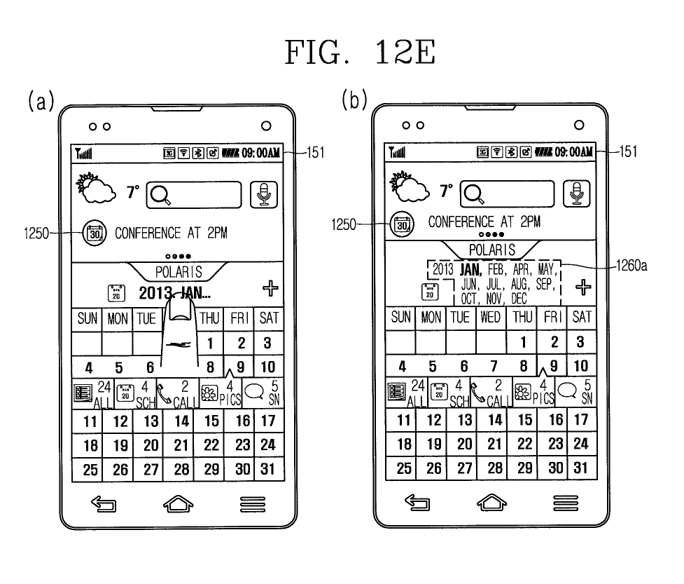

Hereinafter, description will be given in more detail of a method of outputting log information on an idle screen, with reference to the accompanying drawings. FIGS. 12A to 12E are conceptual views illustrating a method of outputting log information on an idle screen in a mobile terminal in accordance with one embodiment.

In a mobile terminal according to one embodiment, as illustrated in (a) of FIG. 12A, log information may be output on an idle screen 1210 using a widget 1211. A type of log information output on the widget 1211 may vary according to a user selection. When a preset type of touch input is applied onto the widget 1211 or a predetermined icon included in the widget 1211, the controller 180, as illustrated in (b) of FIG. 12A, may control the display unit 151 to output screen information for providing log information.

As illustrated in (a) of FIG. 12B, the controller 180 can output a search window 1230 on the idle screen 1210, and receive a search word using the search window 1230 on the idle screen 1210. In addition, as illustrated in (b) of FIG. 12B, the controller 180 can output log information corresponding to the search word entered through the search window 1230.

Meanwhile, in the mobile terminal disclosed herein, as illustrated in (A), (b) and (c) of FIG. 12C, an electronic calendar for providing log information may be output on one home screen page 1242 (see (b) of FIG. 12C) of a plurality of home screen pages 1241, 1242 and 1243. In this instance, the one home screen page 1242 may be divided into an additional information display area 1242a and an electronic calendar display area 1242b.

Types of information to be displayed on the additional information display area 1242a, and controls thereof will be understood by the foregoing description of those embodiments given with reference to FIGS. 10A to 10I. The additional information display area 1242a may continuously be output on the display unit 151 even though the home screen page with the electronic page displayed is switched into another home screen page.

When a first type of touch is applied onto the display unit 151, the controller 180 can output log information related to a category, corresponding to one of the graphic objects, among the collected pieces of log information. When a second type of touch, which is different from the first type of touch, is applied onto the home screen page 1242 with the electronic calendar displayed, the controller 180 can switch the home screen page 1242 with the electronic calendar displayed into another home screen page, while continuously outputting the additional information display area 1242a included in the home screen page 1242 with the electronic calendar displayed as shown in (c) of FIG. 12C.

Here, the first type of touch may be a short touch for selecting the one graphic object of the graphic objects output on the home screen page with the electronic calendar, and the second type of touch may be a drag touch for switching the home screen page with the electronic calendar into the another home screen page.

When a preset type of touch is applied to an additional information display area included in the another home screen page (see 1241 or 1243), the controller 180 can output the electronic calendar on the another home screen page 1241 or 1243.

As illustrated in (a) of FIG. 12D, when a preset type of touch (for example, a drag touch) is applied to an area with the electronic calendar displayed, the controller 180, as illustrated in (b) of FIG. 12D, may output an electronic calendar corresponding to a different month from a month, which has been output before the preset type of touch is applied, on the display unit 151.

When a specific functional icon 1250 is selected while the electronic calendar corresponding to the different month is output, the controller 180 can output an electronic calendar of a month corresponding to the current day.

Also, as illustrated in (a) of FIG. 12E, when a touch is applied to an area 1260 on which a date or a month is displayed, the controller 180, as illustrated (b) of FIG. 12E, may output a GUI, which allows the user to select another month, on the area 1260a. Therefore, when the another month is selected on the area 1260a, the controller 180 can output an electronic calendar corresponding to the selected month.

The aforementioned control method may be equally applied even when the electronic calendar is output on the display unit 151, in addition to the case where the electronic calendar is output on the home screen page.

As described above, in the mobile terminal and the control method according to the one embodiment, log information may be provided by using a widget on an idle screen, enhancing accessibility to the log information for use.

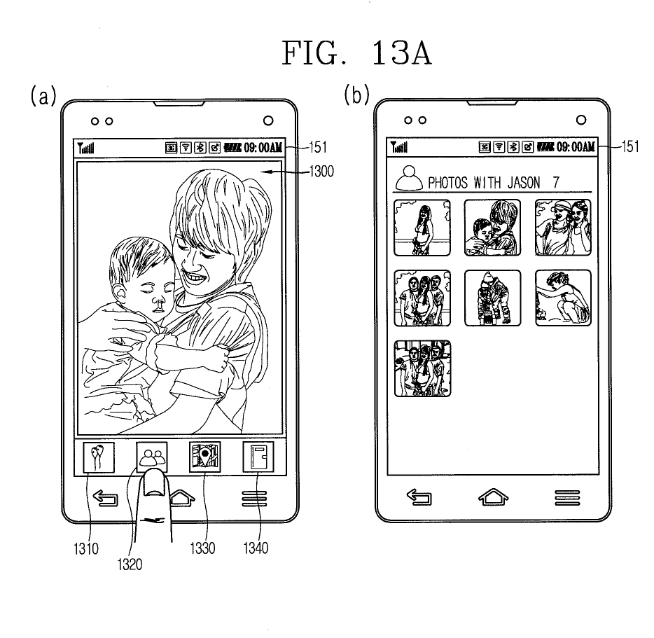

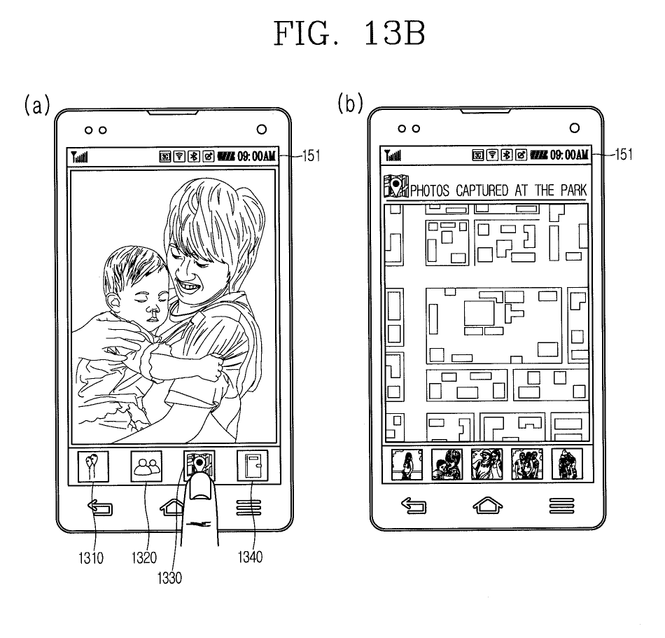

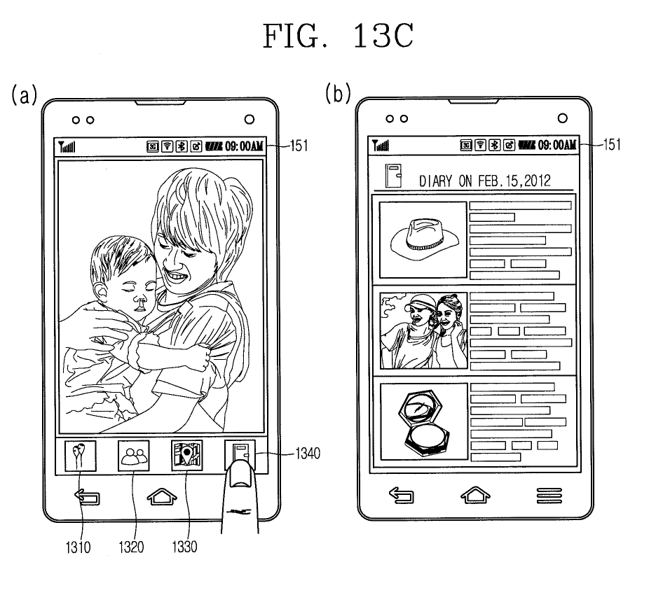

Hereinafter, description will be given in more detail of a method for providing another log information related to log information, or additional information. FIGS. 13A to 13C are conceptual views illustrating a method of providing additional information related to output log information.

The mobile terminal according to the present invention may further provide information related to output log information, or associated other log information. The controller 180 can provide log information or additional information, which includes at least one common information with collected log information. For example, the controller 180 can provide another log information, which has been collected for the same days when the output log information has been collected. In this instance, the output log information and the another log information may have common information, namely, “the same days.”

In order to facilitate an access to the currently-output log information and the another information, the controller 180, as illustrated in (a) of FIG. 13A, may output at least one functional icon 1310, 1320, 1330, 1340 on one area of the display unit 151. When one of the icons is selected, the controller 180 can output information corresponding to the selected icon and simultaneously includes at least one common information with the log information output on the display unit 151. For example, when a “Buddy” icon 1320 is selected while a photo 1300 is output, the controller 180, as illustrated in (b) of FIG. 13A, may output other photos, which include “Buddy” other than the user among persons included in the output photo 1300. The person included in the photo 1300 may be the common information.

As another example, referring to (a) of FIG. 13B, when a “Map” icon 1330 is selected, the controller 180, as illustrated in (b) of FIG. 13B, may output a map corresponding to a position where the photo 1300 has been captured. As another example, referring to (a) of FIG. 13C, when a “Diary” icon 1340 is selected, the controller 180, as illustrated in (b) of FIG. 13C, may output a diary, a memo, a schedule, and the like, which have been written on the captured day of the photo 1300.

As described above, the mobile terminal disclosed herein may provide a UI environment for facilitating an access to other information including at least one common information with output log information.

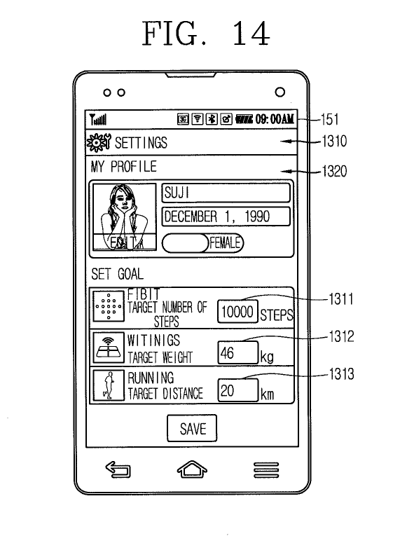

Hereinafter description will be given in more detail of a method of setting personal information, with reference to the accompanying drawings. FIG. 14 is a conceptual view illustrating a method of setting personal information in a mobile terminal in accordance with one embodiment.

In a mobile terminal according to one embodiment, goal information related to a predetermined category may be input by a user, and log information collected in relation to the predetermined category may be used as information for determining whether or not the goal has been achieved.

For example, as illustrated in FIG. 14, the goal information may be a target number of steps, a target weight, a target distance and the like. The controller 180 can count the target number of steps, the target weight, the target distance and the like based on collected log information. The controller 180 can visually output notification (announcement) message when the goal has not been attained. Also, the controller 180 can output notification message for inducing achievement of the goal in a periodic manner.

In addition to those types of goal information, other various types of goal information may also exist, and examples of them may include the number of capturing photos, the number of sending or originating a message or a call to a predetermined person. Referring to FIG. 14, the controller 180 can output a personal information area 1320 to input, modify or delete the personal information (for example, name, sex, birthday, photo, etc.), together with the goal information.

As described above, in the mobile terminal and the control method according to the one embodiment, a target (goal) may be set and notification information related to it is may be provided to help a user to achieve the target (goal).

Also, in the mobile terminal and the control method according to the one embodiment, user environments allowing the log information collected in correspondence with a predetermined day or category to be fast accessible using the electronic calendar may be provided.

Further, in accordance with one embodiment of the present invention, the method can be implemented as computer-readable codes in a program-recorded medium. The computer-readable medium may include all types of recording devices each storing data readable by a computer system. Examples of such computer-readable media may include ROM, RAM, CD-ROM, magnetic tape, floppy disk, optical data storage element and the like. Also, the computer-readable medium may also be implemented as a format of carrier wave (e.g., transmission via an Internet).

The configurations and methods of the mobile terminal in the aforesaid embodiments may not be limitedly applied, but such embodiments may be configured by a selective combination of all or part of the embodiments so as to implement many variations.

The foregoing embodiments and advantages are merely and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the embodiments described herein may be combined in various ways to obtain additional and/or alternative embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a wireless communication unit configured to perform wireless communication;
a display unit configured to display an electronic calendar; and
a controller configured to:
collect log information related to an event generated on the mobile terminal,
receive a selection of a particular day in the electronic calendar,
display graphic objects on the display unit corresponding to different categories in response to the selection of the particular day, and
display collected log information on the display unit for the particular day related to a category corresponding to a selected graphic object.

2. The mobile terminal of claim 1, wherein the controller is further configured to display the collected log information for the selected graphic object when the graphic object is selected and to display the collected log information for the particular day for all displayed graphic objects when another touch action is performed on the display unit rather than the selection of the graphic object.

3. The mobile terminal of claim 1, wherein the log information comprises at least one of a call, message, location, photo, video, social network, health and schedule, and application execution.

4. The mobile terminal of claim 1, wherein the log information includes a list of different log items.

5. The mobile terminal of claim 4, wherein when there is additional log information involved with log information corresponding to one of the log items included in the list, the controller is further configured to display an icon representing the additional log information on one portion of the one log item.

6. The mobile terminal of claim 5, wherein the controller is further configured to display at least part of the additional log information on an area adjacent to the one log item or convert the list into a list including the additional log information, in response to a selection of the icon.

7. The mobile terminal of claim 1, wherein when an item included in the displayed log information is selected, the controller is further configured to execute a preset function involved with the selected item.

8. The mobile terminal of claim 7, wherein when the selected item corresponds to a call, the controller is further configured to call a phone number included in the selected item.

9. The mobile terminal of claim 1, wherein the controller is further configured to display preview information corresponding to log information related to the selected graphic object on one area of the display unit while the graphic object is selected and display log information related to the selected graphic object other than the preview information in response to another touch input.

10. The mobile terminal of claim 1, wherein the controller is further configured to display at least part of the log information corresponding to each category on the corresponding graphic objects.

11. The mobile terminal of claim 1, wherein the controller is further configured to:
receive a preset type of touch input for selecting at least two graphic objects, and
display the log information corresponding to the at least two graphic objects.

12. The mobile terminal of claim 1, wherein the controller is further configured delete a corresponding graphic object in response to a touching and shifting of the corresponding graphic object to a preset area or a touch and drag input starting from the corresponding graphic object and being released after a preset length.

13. The mobile terminal of claim 1, wherein the wireless communication unit is further configured to communicate with an external device through short-range wireless communication, and
wherein the controller is further configured to record data received from the external device as log information.

14. The mobile terminal of claim 13, wherein the controller is further configured to:
display an external device graphic object of the graphic objects to correspond to the external device, and
display the recorded data received from the external device in response to a selection of the external device graphic object.

15. The mobile terminal of claim 1, wherein the controller is further configured to:
sense a touch input on one of the days of the electronic calendar or one of the graphic objects for more than a preset time, and
switch to displaying an idle screen that includes a shortcut icon corresponding to the day or the one graphic object with the touch input sensed for more than the preset time.

16. The mobile terminal of claim 15, wherein the controller is further configured to display log information related to the day or the one graphic object in response to a selection of the shortcut icon on the idle screen.

17. The mobile terminal of claim 1, wherein the controller is further configured to display the log information in a chronological order.

18. The mobile terminal of claim 1, wherein the controller is further configured to:
display the electronic calendar on a first area of a first home screen page,
display situation information on a second area of the first home screen page,
display the log information related to the category of a corresponding graphic object when a first type of touch is applied to the display unit, and
switch the first home screen page into a second home screen page while continuously displaying the situation information included in the second area of the display unit when a second type of touch is applied to the display unit.

19. The mobile terminal of claim 18, wherein the first type of touch is a short touch for selecting the corresponding graphic object, and the second type of touch is a drag touch for switching the first home screen page into the second home screen page.

20. A method of controlling a mobile terminal, the method comprising:
displaying, via a display unit of the mobile terminal, an electronic calendar;
collecting, via a controller of the mobile terminal, log information related to an event generated on the mobile terminal;
receiving a selection of a particular day in the electronic calendar;
displaying, via the controller, graphic objects on the display unit corresponding to different categories in response to the selection of the particular day; and
displaying, via the controller, collected log information on the display unit for the particular day related to a category corresponding to a selected graphic object.
